(19) United States
(12) Patent Application Publication
(10) Pub. No.: US 2025/0038460 A1
(43) Pub. Date: Jan. 30, 2025

(54) 212 GBPS+ CABLE CONNECTOR

(71) Applicant: Amphenol Corporation, Wallingford, CT (US)

(72) Inventors: Khwajahussain Gadwal Mohammed, Nashua, NH (US); Jose Ricardo Paniagua, Newmarket, NH (US); Joseph Passarelli, Nashua, NH (US)

(73) Assignee: Amphenol Corporation, Wallingford, CT (US)

(21) Appl. No.: 18/783,915

(22) Filed: Jul. 25, 2024

Related U.S. Application Data
(60) Provisional application No. 63/515,549, filed on Jul. 25, 2023.

(51) Int. Cl. H01R 13/6597; H01R 12/53; H01R 13/40; H01R 43/20

(52) U.S. Cl. CPC H01R 13/6597; H01R 12/53; H01R 13/40; H01R 43/20

(57) ABSTRACT

A high frequency cable assembly with a plug connector terminating shielded cables via cable termination assemblies mounted to a paddle card. Cable termination assemblies provide paths for ground current between the cable shield and paddle card providing low insertion and return loss and crosstalk at frequencies up to at least 53 GHz, which supports data rates of 224 Gbps and above. Disclosed features of the cable termination assemblies may be used alone or in combination and include: termination of a row of cables, structures configured based on angle of arrival of cables to the cable termination assembly, ground members that align with individual cables, and upper and lower ground members coupled to the cable shield and ground structures of the paddle card that at least partially encircle signal paths outside the cable shields. The upper and lower ground members provide ground current paths paralleling those signal paths with substantially uniform spacing.

### CROSS-REFERENCE TO RELATED APPLICATIONS

This application claims priority to and the benefit of U.S. Provisional Application Ser. No. 63/515,549, filed on Jul. 25, 2023, entitled “212 GBPS+ CABLE CONNECTOR.” The entire contents of this application are incorporated herein by reference in their entirety.

### BACKGROUND

The techniques described herein relate generally to electrical connectors for terminating cables used to transmit high speed signals between electronic devices, such as servers and routers.

Cables are often terminated at their ends with electrical connectors that mate with corresponding connectors in electronic devices, enabling quick interconnection of the electronic devices. A group of cables terminated to a connector forms a cable assembly.

Cables provide signal paths with high signal integrity, particularly for high frequency signals, such as those above 40 Gbps using a non-return-to-zero (NRZ) protocol or above 50 Gbps using a pulse amplitude modulation protocol such as PAM4. Each cable has one or more signal conductors, which is surrounded by a dielectric material. The dielectric material, in turn, is surrounded by a conductive layer, which serves as a ground conductor. A protective jacket, often made of plastic, may surround these components. Additionally the jacket or other portions of the cable may include fibers or other structures for mechanical support.

The components of the cable that predominately impact signal propagation, i.e., the signal conductor, the dielectric and conductive layer, are generally uniform over the length of the cable. Non-uniformities on a signal path, such as might be created by changes in shape or material of the components, give rise to changes in impedance or promote mode conversion, which reduce signal integrity. Loss of signal integrity may be manifested as insertion loss, return loss, crosstalk or other undesirable effects.

One type of cable, referred to as a “twinax cable,” supports transmission of a differential signal. Twinax has a balanced pair of signal wires embedded in dielectric and encircled by a conductive layer serving as a ground conductor. That conductive layer is sometimes referred to as the cable shield.

The conductive layer may be formed using foil, such as aluminized Mylar, or wire braid wrapped around the dielectric. The conductive layer influences the characteristic impedance in the cable and provides shielding that reduces crosstalk between signal conductors in twinax cables that may be routed together as a cable bundle.

A twinax cable can also have a drain wire. Unlike a signal wire, which is generally coated with a dielectric to prevent electrical contact with other conductors in the cable, the drain wire may be uncoated so that it contacts the conductive layer at multiple points over the length of the cable. At an end of the cable where the cable is to be terminated to a connector or other terminating structure, the protective jacket, dielectric and the foil may be removed, leaving portions of the signal wires and the drain wire exposed at the end of the cable. These wires may be attached to a connector. The signal wires may be attached to conductive elements serving as signal contacts in the connector. The drain wire may be attached to ground conductors in the connector, which may serve as ground contacts of the connector. In this way, a ground return path may be continued from the cable through the connector to a component mated to the connector. In drainless cables, the conductive layer may be attached directly to ground conductors in the connector.

A conventional cable connector may include a paddle card to which each of multiple cables is terminated. The paddle card may have conductive pads on a surface near a back edge of the card to which the signal conductors and drain wires of the cables are soldered. A front edge of the card may have contact pads such that, when the paddle card is inserted into a receptacle connector, contacts in the receptacle connector press against the contact pads to mate with the paddle card. Within the paddle card, signal traces and ground structures connect the pads at the rear edge, terminating the cables, to the contact pads, providing conductive paths through the paddle card from the cables to the receptacle connector.

Alternative cable terminal structures are shown in Published U.S. Application 2023/0010530 A1.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an isometric view of an exemplary cable assembly including a plug connector terminating cables, in accordance with some embodiments of the technology described herein.

FIG. 2 is an exploded view of the cable assembly of FIG. 1.

FIG. 3 is an enlarged isometric view of a mating interface portion of the plug connector of the cable assembly of FIG. 1 with a cover of the connector housing removed to reveal cables arranged such that conductors of the cables are in contact with signal terminals of a cable connection assembly.

FIG. 4 is an isometric view of an exemplary cable connection assembly of the plug connector of FIG. 1, which in this example includes a cable termination assembly arranged for a straight connection and a cable termination assembly arranged for a leapfrog connection on each of a top and bottom side of a substrate.

FIG. 5 is a side view of the exemplary cable connection assembly of FIG. 4.

FIG. 6 is an isometric view of an exemplary substrate, here shown as a paddle card, of the exemplary cable connection assembly of FIG. 4.

FIG. 7 is an isometric view of cables connected to an exemplary cable termination assembly configured for a leapfrog connection in the exemplary cable connection assembly of FIG. 4.

FIG. 8 is an isometric view of cables connected to an exemplary cable termination assembly configured for a straight connection in the exemplary cable connection assembly of FIG. 4.

FIG. 9A is an isometric view of the exemplary cable termination assembly of FIG. 8, in a state prior to attachment of upper ground members.

FIG. 9B is an isometric view of an exemplary cable termination assembly, in a state prior to attachment of upper ground members, with an alternative configuration of the upper ground members.

FIG. 10 is an isometric view of the exemplary cable termination assembly of FIG. 8, in a state of manufacture in which signal conductors of one of multiple cables have been terminated to the cable termination assembly.

FIG. 11A is an isometric view from the lower left side of the exemplary cable termination assembly of FIG. 8, in a state of manufacture in which a lower ground member has been attached.

FIG. 11B is an isometric view from the lower left side of the exemplary cable termination assembly of FIG. 11A, in a state of manufacture prior to attachment of the lower ground member.

FIG. 12 is an isometric view of a an exemplary leadframe of the exemplary cable termination assembly of FIG. 8.

FIG. 13 is an isometric view of cables connected to an exemplary cable termination assembly configured for a leapfrog connection in the exemplary cable connection assembly of FIG. 4.

FIG. 14 is an isometric view of cables connected to the exemplary cable termination assembly of FIG. 13, with an insulative housing of the cable termination assembly cutaway.

FIG. 15 is a partially exploded isometric view of the exemplary cable termination assembly of FIG. 14, with a lower ground member and one upper ground member, but without cables attached.

FIG. 16A is an S Parameter Plot showing insertion loss and return loss on two signal paths through a cable termination assembly configured for a straight connection and a cable termination assembly configured for a leapfrog connection, respectively using techniques as described herein, with a ground cover as shown in FIG. 9A.

FIG. 16B is an S Parameter Plot showing insertion loss and return loss on two signal paths through a cable termination assembly configured for a straight connection and a cable termination assembly configured for a leapfrog connection, respectively using techniques as described herein, with a ground cover as shown in FIG. 9B.

### DETAILED DESCRIPTION

The inventors have recognized and appreciated structures for providing a cable assembly capable of operating above 56 Gbps (PAM4), including up to and above 212 Gbps, such as up to 224 Gbps or higher. The cable assembly may have a connector incorporating one or more features to control the electrical and/or mechanical connection between the cables and a paddle card. These features may provide reliable conductive paths for both signal and ground energy as well as stable and controlled relative positions of conductive elements within the connector, which contributes to high integrity signal paths through the connector despite variations that can occur during manufacture and/or use of the connector.

One or more of the features described herein may provide ground paths within the connector from the cable shield to ground structures of the paddle card that enable very high frequency performance of the cable assembly. Ground paths resulting from one or a combination of the techniques described herein may result in a cable assembly with return loss through the connector of less than −10 dB and insertion loss below 1 dB at frequencies up to at least 53 GHz. Despite a high density of such high-speed signal channels through the connector, configurations as described herein may support worst case multiactive cross talk of less than −5 dB at frequencies up to at least 53 GHz. This level of signal integrity may be adequate to support signals beyond 212 Gbps (PAM4), including up to 224 Gbps or higher.

As one example of a feature that may improve signal integrity, a cable connector may have one or more cable termination assemblies. Each cable termination assembly may terminate multiple cables to a paddle card. Signal paths may be provided via signal terminals in the cable termination assemblies with tails attached to signal conductors of the cables and mounting ends attached to pads on the paddle card.

A ground member in the cable termination assembly may be disposed between the cables and paddle card and may have portions attached to ground structures of the paddle card. This lower ground member, for example, may be surface mount soldered to one or more ground pads on a surface of the paddle card.

Optionally, the lower ground member may have a portion that is parallel to a plane in which a group of cables terminated to the cable termination assembly are arrayed. This parallel portion may be aligned with portions of the cables along which the cable shield is exposed. This parallel portion may be electrically coupled to the cable shields along their exposed portions. The parallel portion may be parallel to or bent at an angle relative to mounting portions of the lower ground member coupled to the ground structure of the paddle card. In some examples, the relative angle of the mounting portions and the parallel portion of the lower ground member may be set based on the angle of arrival of the cables relative to a surface of the cable termination assembly configured to be mounted against a surface of the paddle card.

Alternatively or additionally, a cable termination assembly may include one or more ground members above the cables. Optionally, there may be one upper ground member per cable. The upper ground members may provide both electrical and mechanical connection to one or more of the cables. The upper ground members, for example, may contact the shields of the cables. A portion of each upper ground member contacting a cable shield may provide mechanical alignment and/or support for the cable. Multiple upper ground members per cable termination assembly enables the upper ground members to align with each of multiple cables. The upper ground members may provide substantially the same grounding structures around the conductors of all of the cables, despite variations in the spacing or orientation of one or more of the cables with respect to the cable termination assembly.

The upper and/or lower ground members may provide ground current paths that provide insertion loss and return loss sufficiently to support high frequency signals. Optionally, the upper and/or lower ground members may have portions that each partially surrounds a portion of the signal conductors of a cable and/or signal terminals within the cable termination assembly. In preparing a cable for termination to a connector, a portion of the cable shield at the end of the cable may be removed such that portions of the signal conductors extend beyond the cable shield. These portions of the signal conductors of the cable may be attached to signal terminals within the cable termination assembly, extending the signal path from the cable to the paddle card. Portions of the upper and/or lower ground members may at least partially surround these signal paths. These portions of the upper and/or lower ground members may be concave such that the upper and lower ground members cooperate to at least partially surround portions of the signal conductors of each of the cables and/or portions of the signal terminals.

Optionally, the cable termination assembly may include ground terminals. The ground terminals may be interspersed with signal terminals in a row. The signal terminals carrying one signal may be bordered on each side within the row by a ground terminal. For signal terminals terminating a twinax cable, for example, a pair of signal terminals may carry one differential signal and each pair of signal terminals may be bounded on each side by a ground terminal.

Optionally, the ground terminals may be electrically connected via a ground strip. Optionally, the upper and/or lower ground members may be electrically and/or mechanically connected to the ground terminals and/or ground strip, such as by welding or soldering.

The upper and/or lower ground members may be electrically coupled to both the cable shields and ground structures on the paddle card. Each, for example, may be coupled at one end to the cable shields and at the other end to at least one ground structure on the paddle card. For coupling the upper and/or lower ground members to the cable shields, portions of the cables with exposed shields may be captured between the ground strip and one of the upper or lower ground member, for example, providing mechanical attachment and/or electrical connection between one of the ground members of the connector and the cable shield. The other of the upper or lower ground members may be connected to the ground strip and/or ground terminals such as through soldering or welding.

For coupling the upper and/or lower ground members to ground structures on the paddle card, either or both ground members may have portions configured for surface mount soldered to the paddle card. Alternatively or additionally, either or both of the upper and lower ground members may have portions, such as mounting arms, attached to the ground terminals at the ends at which the ground terminals are attached to ground structures of the paddle card.

Either or both of the upper and lower ground members may have intermediate portions connecting the portions coupled to the cable shields with the portions coupled to the ground terminals. These intermediate portions may extend parallel and adjacent to signal paths through the cable conductors and signal terminals within the cable termination assembly. These intermediate portions of the upper and lower ground members may provide ground current paths that provide high signal integrity. The upper and lower ground members may be shaped, for example, such that these ground current paths parallel the signal paths separated by a distance along the signal paths that provides a substantially uniform impedance along the signal path. Such a construction may provide low insertion loss, low return loss and/or low crosstalk among the signal paths within a cable termination assembly or across cable termination assemblies in a cable connection assembly with multiple cable termination assemblies.

The inventors have further recognized and appreciated that at high frequencies, such as frequencies above 56 Gbps (PAM4), variations in the relative position of the ground structures of the connector and the cable shield relative to designed locations may disrupt the ground paths through the connector sufficiently to increase insertion loss and/or return loss of signal paths through the cable assembly and/or crosstalk between the signal paths. Components as described herein, such as upper and lower ground members, may be designed to provide low variations of this type. Nonetheless, such variations may arise during manufacture of a cable assembly from variability in processes for holding the components together or may arise during use because of forces applied to the cables or other components. Some techniques optionally may reduce the impact of such variations. Having separate upper ground members per cable, for example, may facilitate alignment of the upper ground member with the cable shield for each of multiple cables, which reduces the impact on signal integrity of variations in the position of the individual cables with respect to the cable termination assembly.

The inventors have further recognized and appreciated that twinax cables with diameters larger than 28 AWG, such as 26 AWG or larger, may provide lower insertion loss and/or return loss than smaller diameter wires. However, the inventors theorize that this benefit may be offset by imprecise positioning that results from the stiffness of the cables with signal conductors of these larger sizes. Accordingly, multiple upper ground member in combination with cables with larger wire diameters may provide lower return loss and/or insertion loss in two ways.

Yet other features, alternatively or additionally, may ensure that that cables are held in the cable assembly to position cables relative to conductive structures of the cable termination assembly in an orientation that provides ground and/or signal paths through the connector with high signal integrity. Optionally, a connector may have a cable positioning member that aligns cables relative to conductive structures in the connector to which the cables are to be attached. A cable connector, for example, may have mounting locations for multiple cables separated in a row on a desired pitch. The positioning member may hold those cables in a row on the desired pitch. For connectors with multiple rows of cable terminations, a positioning member may hold multiple such rows of cables. Such a cable positioning member may be formed, for example, by overmolding a material on the cables to be terminated within the connector.

Alternatively or additionally, a connector may have one or more cable termination assemblies with conductive structures oriented to conform with the orientation of cables terminated to the termination subassembly. A first group of cables routed to a first cable termination assembly mounted nearest an edge of a paddle card in the connector may approach the termination subassembly at a first angle relative to the surface of the paddle card. A second group of cables routed to a second cable termination assembly mounted away from the edge may approach the second termination assembly at a second angle relative to the surface of the paddle card. The first angle may be smaller than the second angle. Such an orientation enables the cable termination assemblies to be closely spaced, leading to a more compact electronic system, while limiting forces on the cables that would otherwise tend to move them from a desired location with respect to conductive structures in the cable termination assemblies.

In some examples, the first angle may be near zero, meaning that the cables approach the first termination assembly in a direction parallel to a surface of the paddle card. The first angle, for example, may be in a range of +/−5 degrees. The second angle may be larger, which may accommodate the second group of cables passing over the first cable termination assembly such that the ends of the cables extend downwards toward the paddle card as they approach the second cable termination assembly. The second angle, for example, may be larger than 5 degrees, or larger than 10 degrees, such as between 10 and 30 degrees, in some examples.

Optionally, a connector may have multiple cable termination assemblies, which may have different shapes to provide comparable ground structures for all the cables routed to multiple cable termination assemblies. Different shapes may alternatively or additionally facilitate manufacture of the cable termination assembly. Each cable termination assembly, for example, may have a lower surface configured for mounting against a paddle card. Signal terminals and ground terminals, in some examples, may be held in a row in a housing of the terminal subassembly, such as by insert molding. These terminals may be elongated in a direction that parallels the direction in which cables approach the terminal assembly, such that the terminals extend at an angle relative to the surface configured for mounting against the paddle card. Sides of the housing may be orthogonal to the elongated direction of the terminals such that the sides of the housing are not orthogonal to the surface configured for mounting against the paddle card.

Structures as describe herein may facilitate economical fabrication of cable assemblies. Optionally, a cable connection assembly may be formed with a plurality of cable termination assemblies. The cable termination assemblies may be formed by insert molding, for example. A lower ground member may be attached to each of the cable termination assemblies, such as via welding to ground terminals and/or a ground strip within the cable termination assembly. One or more such cable termination assemblies, with attached lower ground members, may be mounted to a substrate, such as a paddle card. The cable termination assemblies may be mounted via surface mount soldering, for example.

Optionally, a cable bundle to be terminated with a cable connector may be prepared for termination to the cable connection assembly. Cables of the bundle, for example, may be separated and optionally may be fixed via a cable positioning member. The cables may have their jackets stripped at the end to expose a cable shield. A portion of the cable shield and underlying cable insulators may be removed, exposing the cable signal conductors at the distal ends of the cables, with an adjacent segment of exposed cable shield on each of the cables.

The exposed signal conductors may be connected to wire connecting ends of the signal terminals, such as via soldering. The cables may rest within the cable termination assemblies with exposed cable shields contacting the ground strips and/or ground terminals of the cable termination assemblies. Optionally, upper ground members may be attached to each of the cable termination assemblies, which may press against the exposed cable shields and/or press the exposed cable shields against the ground strips and/or ground terminals of the cable termination assemblies. Upper ground members may be attached such as by soldering, for example.

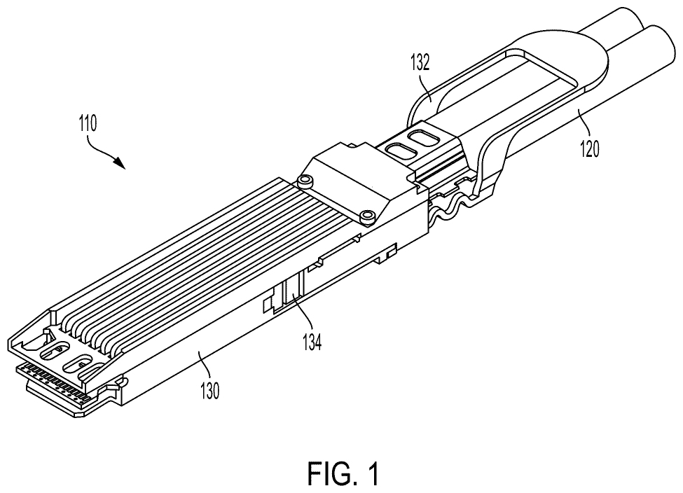

These techniques and features may be used together in any suitable combination or may be used individually. FIGS. 1-3 provide an example of a cable assembly in which techniques as described herein may be applied to achieve high speed cable assembly.

FIG. 1 is an isometric view of an exemplary cable assembly 110 including a plug connector 130 terminating cables 214 within cable bundles 120, using one or more of the techniques described herein. The cable bundles 120 house cables 214.

Within cable connector 130, the cables 214 may be separated from the cable bundles 120 and terminated to a paddle card 211. Contact pads on paddle card 211, which are connected to the cables within cable connector 130, are visible in FIG. 1.

Cable connector 130 optionally may include features that facilitate mating with an electronic device. Latching structures 134, for example, may engage a mating connector. A pull tab 132 may facilitate disengagement of the latching structures 134 from the mating connector such that cable connector 130 may be disengaged from a mating connector (not shown).

Other features optionally may be present. For example, cable connector 130 may include a heat sink 230. In this example, the heat sink 230 forms a portion of the outer housing of connector 130. Heat sink 230 may engage with outer housing portion 240 to bound a cavity 242.

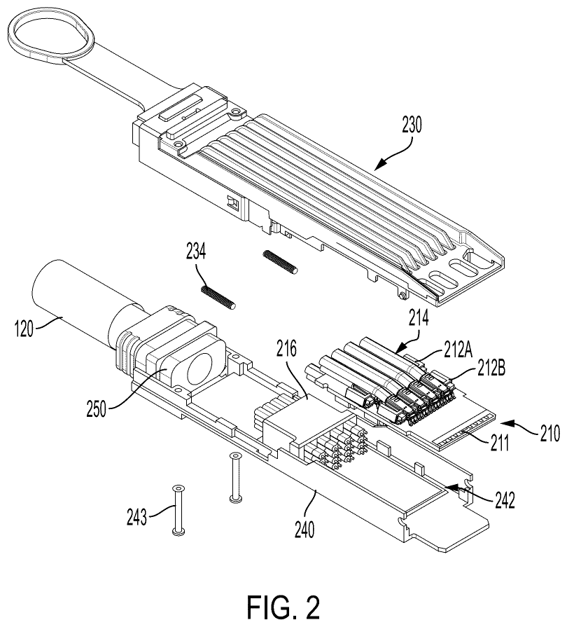

FIG. 2 is an exploded view of the cable assembly of FIG. 1. As shown in FIG. 2, cables 214 may be routed to terminate on one or more sides of a substrate, here illustrated as paddle card 211. Paddle card 211 may be disposed within cavity 242, formed within a housing of the connector. In some embodiments, the cables 214 may be routed such that a portion of cables 214 terminates on a first side of a paddle card 211 and a portion of cables 214 terminates on an opposing second side of paddle card 211. One or more of the features described herein may be used to terminate the cables to paddle card 211 to provide high integrity signal connections that support high speed signal such as above 212 Gbps.

In some embodiments, the cable connector 130 may include springs 234, bolts 242, and a gasket 250 to secure various components of the cable connector within the outer housing 240. Each of the cables (214) may contain at least one wire and a shield. The cable connector 130 may terminate the cables 214. The cable connector 130 may include a paddle card 211 having a first side having a plurality of signal pads and at least one ground pad. The cable connector may further include cable termination assemblies 212A, 212B mounted to the first side of the paddle card 211.

In the pictured example, cable connector 130 includes a cable connection assembly 210 to which cables 214 are terminated. In this example, cable connection assembly 210 includes a substrate, such as paddle card 211, and cable termination assemblies mounted to it. Cable termination assemblies may be mounted to one or both sides of paddle card 211. In the illustrated example, cable termination assemblies are mounted on both sides. In this example, two types of cable termination assemblies are mounted on each side of paddle card 211. Cable termination assembly 212A is configured for mounting near a rearward edge of paddle card 211, closest to the location from which the cables 214 are routed to the cable connection assembly 210. Cable termination assembly 212B is mounted closer to the forward edge of paddle card 211, closest to the mating pads on the paddle card.

In the example illustrated, cable termination assembly 212B is configured for a leapfrog connection because the cables terminated to cable termination assembly 212B first pass over cable termination assembly 212A. As a result, the cables approach cable termination assembly 212B from an angle relative to the surface of the paddle card and/or the lower surface of the cable termination assembly 212B, which is mounted to the paddle card. In contrast, cable termination assembly 212A is configured for a straight connection. The ends of the cables terminated to cable termination assembly 212A are straight and approach cable termination assembly 212A parallel to the surface of the paddle card and/or the lower surface of the cable termination assembly 212A, which is mounted to the paddle card.

For simplicity of illustration only segments of the cables 214 are shown and these segments are shown as discontinuous. For example, segments at the ends of the cables 214 approaching each of the cable termination assemblies are shown attached to the cable termination assemblies, which, in turn are shown mounted to a paddle card. That structure is shown exploded from the connector housing. Another segment of the cables 214 are shown passing through cable positioning member 216. Segments passing through gasket 250 are not shown. In a cable assembly, however, each of the cables 214 may extend continuously from cable bundle 120, through gasket 250 and then through cable positioning member 216 to a cable termination assembly.

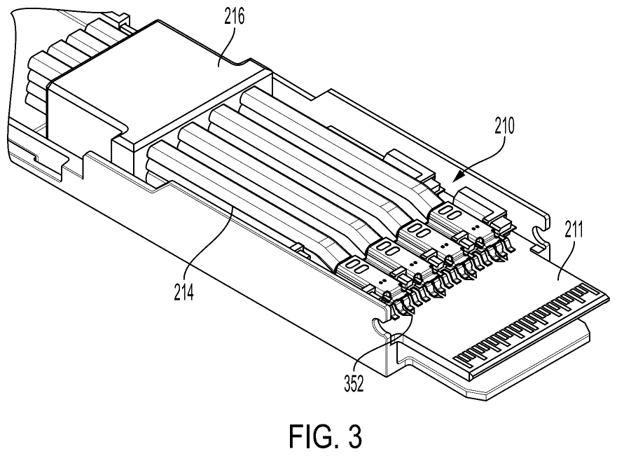

FIG. 3 is an enlarged isometric view of a mating interface portion of the plug connector of the cable assembly of FIG. 1 with a cover of the connector housing removed to reveal cables arranged such that conductors of the cables are in contact with signal terminals of a cable connection assembly. In the pictured example, the exemplary cable assembly includes a cable connection assembly 210, including a paddle card 211 with cable termination assemblies. In the example of FIG. 3, cables 214 are terminated to the cable termination assemblies of the cable connection assembly. Those cables are aligned with the respective cable termination assemblies by a cable positioning member 216. The cable positioning member 216 may hold the cables 214 within a cavity of the housing of cable connector 130. Each of the cable termination assemblies may terminate multiple cables (four in the illustrated example). In this example, the cables terminated to each cable termination assembly are aligned side by side in a plane. Conductors of the cables are terminated to a row of terminals in the cable termination assemblies. Those terminals are mounted at their ends to mounting pads on the surface of the paddle card, such as by surface mount soldering. In FIG. 3, for example, a row of mounting ends 352 of the terminals of one cable termination assembly is visible.

In the example illustrated, cable connection assembly 210 includes four cable termination assemblies. In this example, cable positioning member 216 holds the cables 214 in four rows, with the cables in each row in a plane. The spacing of cables in each row may match the spacing of signal terminals in the cable termination assembly to which the cables are terminated.

In correspondence with FIG. 2, FIG. 3 shows a discontinuity in the cables 214 between cable positioning member 216 and the cable connection assembly 210. However, that discontinuity is for simplicity of illustration and may not be present in a cable connector implemented as described herein.

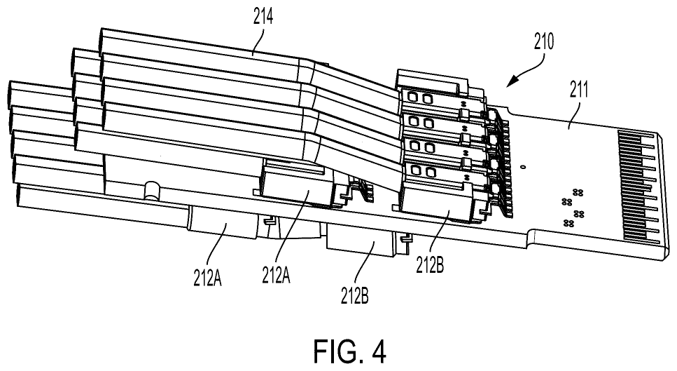

FIG. 4 is an isometric view of an exemplary cable connection assembly of the plug connector of FIG. 1, which in this example includes a cable termination assembly 212A arranged for a straight connection and a cable termination assembly 212B arranged for a leapfrog connection on each side of the paddle card 211. Each of the cables 214 may carry a high-speed signal either to or from the paddle card. Each of the cables, for example, may carry a high-speed low voltage differential signal. The signal may have components at high enough frequency with high enough signal integrity to support 212 or greater Gbps (PAM4), such as 224 Gbps or an upper limit in a range of 212 to 230 Gbps, for example.

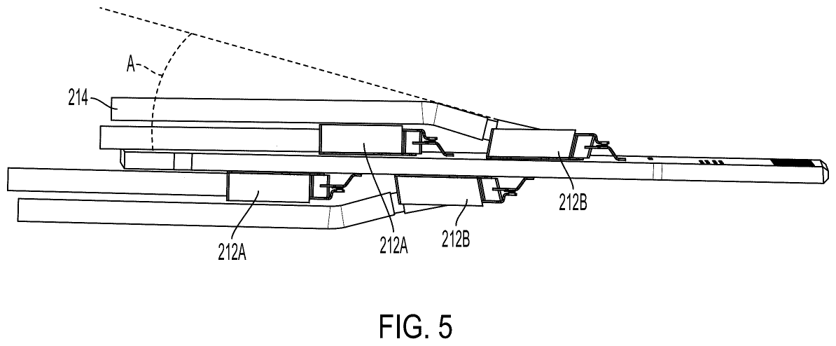

FIG. 5 is a side view of the exemplary cable connection assembly 210 of FIG. 4.

As pictured, a first set of cables is connected to the cable termination assembly 212B toward a front edge of a first side of the paddle card 211 and a second set of cables is connected to the cable termination assembly 212A toward a rear edge of the first side of the paddle card. Both the cable termination assembly 212B and the cable termination assembly 212A are mounted to the first side of the paddle card 211. As pictured, the first set of cables connected to the cable termination assembly 212B passes over the second set of cables connected to the cable termination assembly 212A.

In some embodiments, ends of the second set of cables terminated at the cable termination assembly 212B toward a front edge of the first side of the paddle card 211 may be disposed in a first plane at an acute angle A with respect to the first side of the substrate. In some embodiments ends of the first set of cables terminated at the cable termination assembly 212A toward the rear edge of the first side of the paddle card 211 may be disposed in a second plane substantially parallel to the first side of the paddle card 211.

As pictured, a third set of cables may be connected to the cable termination assembly 212B toward a front edge of a second side of the paddle card 211 and a fourth set of cables may be connected to the cable termination assembly 212A toward a rear edge of the second side of the paddle card. Both the cable termination assembly 212B and the cable termination assembly 212A are mounted to the second side of the paddle card 211. The third set of cables connected to the cable termination assembly 212B may pass over the fourth set of cables connected to the cable termination assembly 212A on the second side of the paddle card 211.

In some embodiments, ends of the fourth set of cables terminated at the cable termination assembly 212B toward a front edge of the second side of the paddle card 211 may be disposed in a first plane at an acute angle with respect to the second side of the substrate. In the illustrated example where the cable termination assemblies mounted on each side of the paddle card have the same configuration, the acute angle may be the same as angle A. In other examples, however, the acute angles may be different. In some embodiments ends of the third set of cables terminated at the cable termination assembly 212A toward the rear edge of the second side of the paddle card 211 may be disposed in a second plane substantially parallel to the second side of the paddle card 211. That is, two cable termination assemblies along with the cables connected to them may be disposed on one side of the paddle card 211 and two different cable termination assemblies along with the cables connected to them may be disposed on the other side of the paddle card 211.

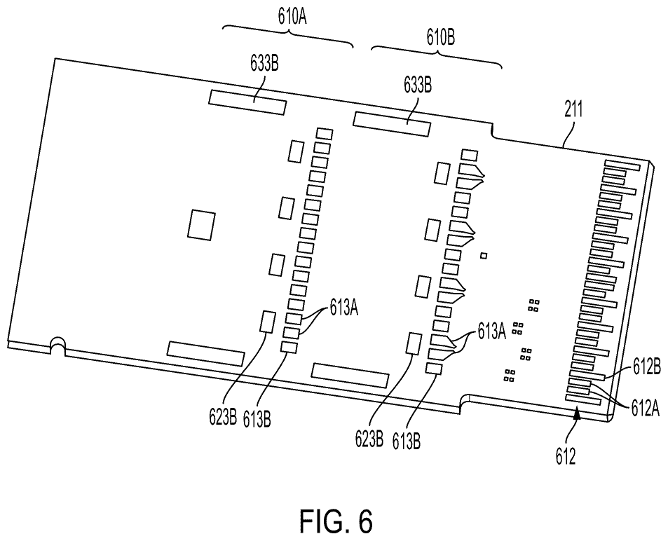

FIG. 6 is an isometric view of an exemplary substrate of an exemplary cable connection assembly, in accordance with some embodiments of the technology described herein. In this example, the substrate is a paddle card 211. As pictured, the paddle card 211 includes a plurality of contact pads 612 disposed parallel and adjacent to a first edge shown at the right in FIG. 6. For mating cable connector 130 to a receptacle connector (not shown), the first edge may be inserted into the receptacle connector. Accordingly, the contact pads 612 may be shaped and positioned to mate with terminals in the receptacle connector. The contact pads 612, are in this example, arranged according to an OSFP a standard for mating to an OSFP receptacle.

The paddle card 211 has a second edge shown at the left in FIG. 6, opposite the first edge. As can be seen, for example in FIG. 4, the cables 214 are routed to the cable termination assemblies from the direction of the second edge of the paddle card.

Between the contact pads 612 and the second edge, paddle card 211 has pads on a surface that support mounting of cable termination assemblies and associated ground members. The pads are organized into footprints 610A or 610B, with each footprint including signal and ground pads associated with each cable termination assembly. In the illustrated example, footprint 610A is closer to the second edge and footprint 610B closer to the first edge of paddle card 211. In this example, footprint 610A includes mounting pads for mounting cable termination assembly 212A and footprint 610B includes mounting pads for mounting cable termination assembly 212B. In this example, footprint 610A and 610B have the same configuration of signal and ground pads.

The second side of the paddle card may have one or more similar footprints for mounting cable termination assemblies to the second side of the paddle card. To support mounting of cable termination assemblies in the configuration of FIG. 5, the footprints 610 on the second side of the paddle card may be offset in the front to back direction (i.e. from the first edge towards the second edge) relative to the footprints on the first side of the paddle card.

In the example illustrated, each of the footprints 610A or 610B includes signal pads 613a arranged in a row. Each signal pad may be connected to a signal trace within the paddle card 211. The traces may connect signal pads 613a to signal contact pads 612a. Ground pads 613b may be interspersed in the row with the signal pads 613a. The ground pads 613b may be connected through structures within the paddle card to ground contact pads 612b. In the illustrated example, the signal pads are arranged in pairs, with a ground pad on each side of each pair. Such a row of signal and ground pads may provide mounting locations for mounting ends 352 of the signal and ground terminals within a cable termination assembly.

Additionally, each footprint 610A and 610B includes ground pads for other ground structures associated with a cable termination assembly. In this example, ground pads 623b and 633b support mounting of portions of a lower ground member, as described below.

The arrangement of footprints shown in FIG. 6 enables one cable termination assembly to be mounted closer to the second edge of the paddle card 211 and another cable termination assembly may be mounted closer to the first edge of the paddle card 211. As pictured in FIG. 6, a first plurality of signal pads (613a) extends in a first row, parallel to the first edge; and a second plurality of signal pads (613a) extends in a second row, parallel to the first row.

A paddle card may include at least one ground pad. In the example of FIG. 6, each mounting location for a ground terminal of a cable terminal assembly or a mounting portion of an associated ground member is shown as a separate pad. Such pads may be connected through ground structures within the paddle card. Alternatively, some or all of the conductive material on the surface of the paddle card identified as ground pads may be contiguous over all or parts the surface of the paddle card, excluding the area surrounding each of the signal pads.

In the example of FIG. 6, the ground pads are arranged with a first plurality of ground pads (613b) within the first row. A second plurality of ground pads (613b) are arranged within the second row. A third plurality of ground pads (623b) are arranged in a third row parallel to the first row and between the first row and the second row. A fourth plurality of ground pads (623b) are arranged in a fourth row parallel to the second row and between the second row and the second edge. As an example, a first plurality of ground terminals on a cable termination assembly may be mounted to the first plurality of ground pads (613b) within the first row on the paddle card 211. In addition, a second plurality of ground terminals on a cable termination assembly may be mounted to the second plurality of ground pads 613b within the second row on the paddle card 211. In addition, mounting portions of a ground member on a cable termination assembly may be mounted to the third plurality of ground pads 623b in the third row on the paddle card 211. In addition, mounting portions of a ground member on a cable termination assembly may be mounted to the fourth plurality of ground pads 623b in the fourth row on the paddle card 211.

As a further example of arrangement of ground pads, the paddle card may have a side extending between the first edge and the second edge, and the ground pads may further include a first elongated ground pad 633b, elongated in a direction parallel to the side. The ground pads of the paddle card 211 may further comprise a second elongated ground pad 633b, elongated in the direction parallel to the side. A side portion of a ground member on a cable termination assembly may be mounted to the first elongated ground pad (633b) on the paddle card 211. A side portion of a ground member on a cable termination assembly may be mounted to the second elongated ground pad 633b on the paddle card 211.

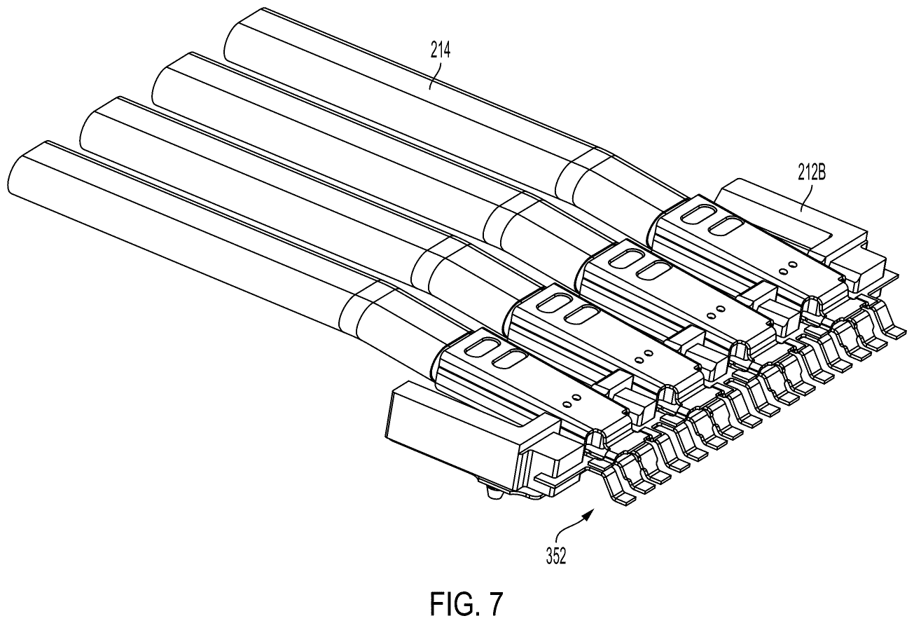

FIG. 7 is an isometric view of cables 214 connected to an exemplary cable termination assembly 212B configured for a leapfrog connection in the exemplary cable connection assembly of FIG. 4 For simplicity, no paddle card or other substrate is shown. A set of cables 214 may be connected to the cable termination assembly 212B. These cables may be connected to the cable termination assembly after it is mounted to a paddle card such that FIG. 7 may, but need not, indicate an order of assembly of components of a cable assembly.

In the example illustrated, ends of the cables terminated at the cable termination assembly 212B are disposed in a first plane at an acute angle with respect to a surface of a substrate, such as a paddle card, to which the cable termination assembly will be mounted. Alternatively or additionally, the same angle may be determined with respect to a face of the cable termination assembly configured for mounting against the substrate or with respect to another structure configured for mounting to the surface of the substrate. The angle may be the angle A, such as is indicated in FIG. 5.

In some embodiments, the acute angle may be greater than 5 degrees, such as an angle within the range of 5 to 45 degrees or 5 to 30 degrees. A set of cables 214 may be connected to the cable termination assembly 212A.

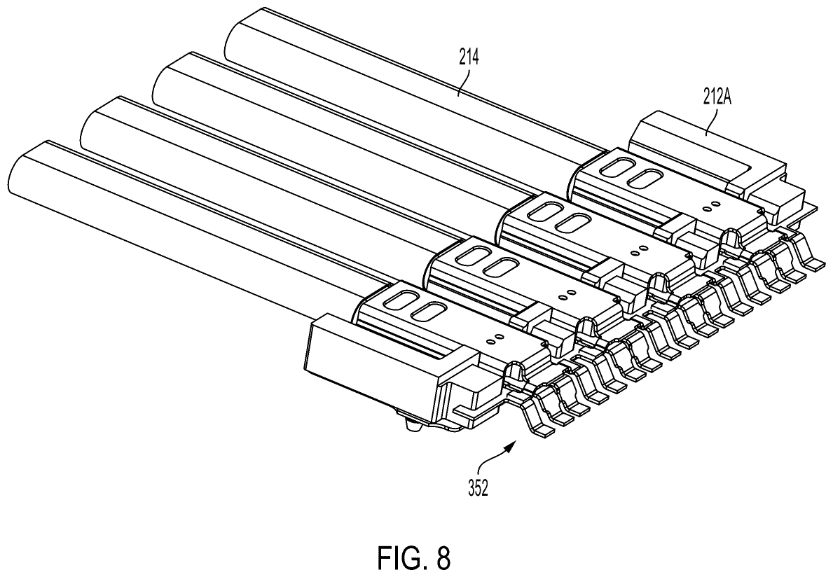

FIG. 8 is an isometric view of cables 214 connected to an exemplary cable termination assembly 212A configured for a straight connection in the exemplary cable connection assembly of FIG. 4 In the example illustrated, ends of the cables terminated to the cable termination assembly 212A are disposed in a plane, which is substantially parallel to a surface of a substrate, such as a paddle card, to which the cable termination assembly will be mounted. Alternatively or additionally, the same angle may be determined with respect to a face of the cable termination assembly configured for mounting against the substrate or with respect to another structure configured for mounting to the surface of the substrate. In some embodiments, the angle may be less than 5 degrees, such as within the range of +/−5 degrees. A set of cables 214 may be connected to the cable termination assembly 212A.

In the example illustrated, both cable termination assemblies 212A and 212B include the same components and are similarly associated with ground members such that both are assembled, mounted and terminated to cables in the same way. The components of both cable terminations assemblies 212A and 212B, however, are configured such that the portions of the signal terminals, ground terminals and other structures that are connected to conductive structures of the cables 214 are oriented to parallel to the ends of the cables. Accordingly, the components of cable termination assemblies 212A and 212B and associated ground members will differ in that portions of those components for cable termination assembly 212B will be angled with respect to the corresponding portions of the components of cable termination assembly 212A. The relative angle between the portions of the components of cable termination assemblies 212A and 212B may be the angle A, such as is indicated in FIG. 5.

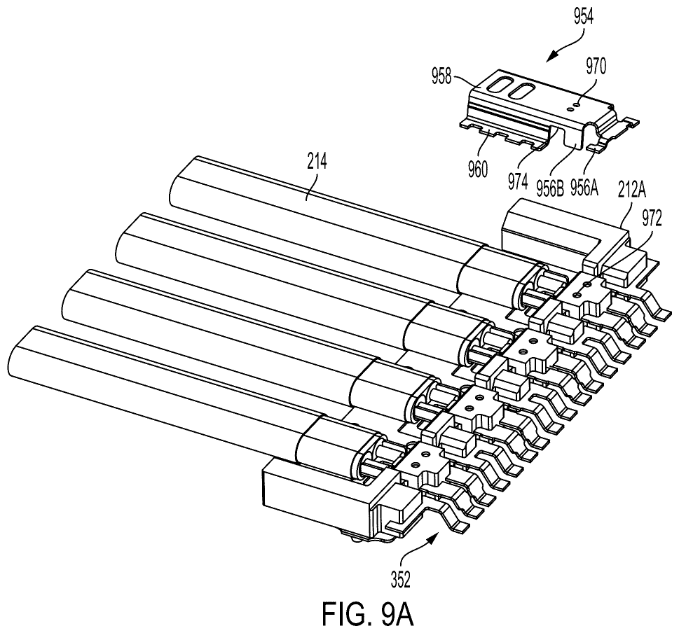

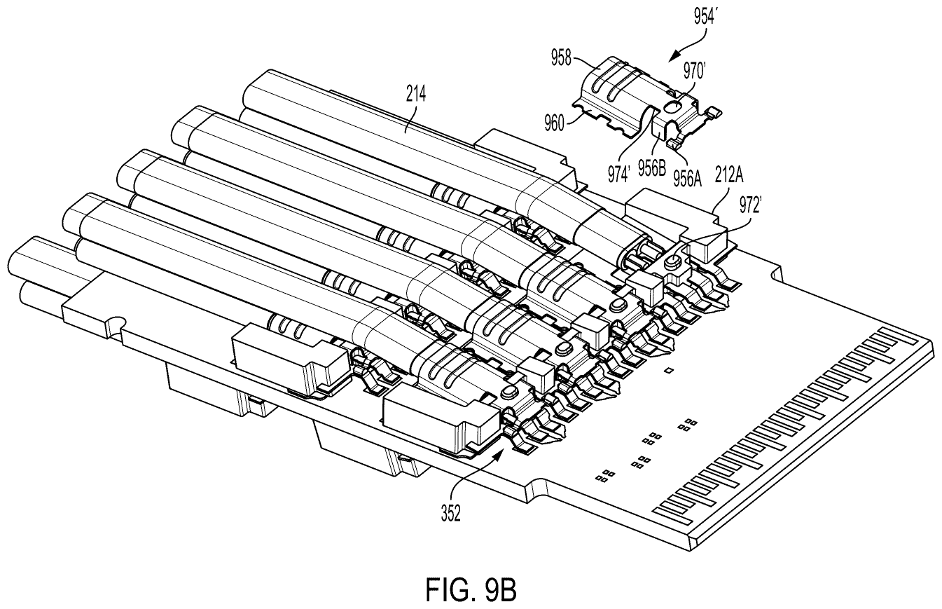

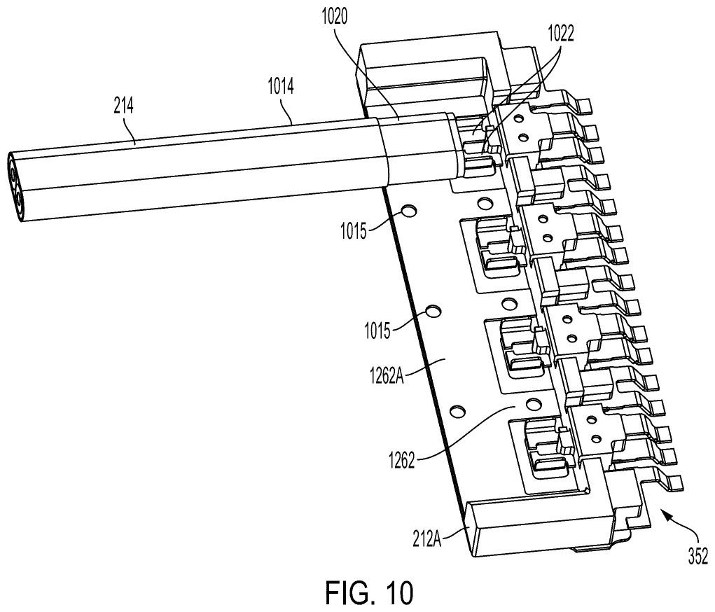

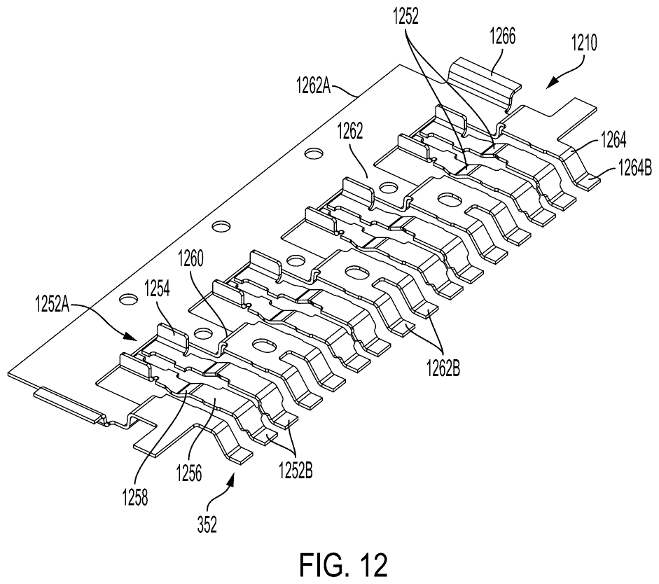

FIG. 9A is an isometric view of the exemplary cable termination assembly 212A of FIG. 8, in a state prior to attachment of upper ground members 954. As pictured, a set of cables 214 are connected to a cable termination assembly 212A. As further shown in FIGS. 10 and 12, an end of the cable 214 has been prepared for termination by removing the cable jacket 1014. FIG. 10 illustrates one terminated cable. Each of multiple cables in a set terminated to a cable terminated assembly may be terminated in the same way. Removing jacket 1014 exposes a cable shield 1020 over a segment of the cable. In this example, in the distal segment of the cable, the cable shield as well as underlying insulator are also removed, exposing signal conductors 1022. The exposed signal conductors 1022 are attached to the mounting ends 1252B of signal terminals within the cable termination assembly. The signal conductors 1022 may be soldered to the mounting ends 1252B, for example. In the example illustrated, the mounting ends 1252B include wings 1254 which may facilitate soldering.

In the illustrated example, the cable shield 1020 is coupled to ground terminals 1262 of the cable termination assembly. The cable shield may be coupled to a ground terminal via a force pressing the segment of the cable with exposed shield against the ground terminal and/or other conductive structure that is connected to the ground terminal. In the example illustrated, each of multiple ground terminals are connected to a ground strip 1262A and the exposed cable shield 1020 rests on ground strip 1262A. A ground member may be attached to the cable termination assembly over that portion of the cable, which may generate a force the end of the cable that presses the segment with exposed cable shield into the ground strip 1262A or other conductive structure coupled to the ground terminals.

In the example of FIG. 9A, an upper ground member may be attached over the end of the cable. As can be seen in FIGS. 8 and 9A, a separate upper ground member may be attached for each of the cables. An example of an upper ground member is ground member 954. Ground member 954 may include a portion at one end to connect to a cable shield and, at the opposite end, one or more portions to connect to respective ground terminals near their mounting ends. In this example, each of the ground members 954 has arms 956A and 956B, a concave portion 958, and a flange 960.

The concave portion of the ground member 954 is configured to be positioned over an end of a cable 214. When the flange 960 is attached to a ground structure including the ground strip and one or more ground terminals, the concave portion will urge the cable toward the cable termination assembly 212A. Such attachment made be achieved by soldering ground flange 960 to the ground strip 1262A and/or one or more ground terminals, such as ground terminals 1262 and 1264 (FIG. 12). In FIG. 9A, a flange 960 on one side of ground member 954 is visible. Ground member 954 may have a flange on each side, each of which may be attached to the ground strip and/or one or more ground terminals. In examples in which an upper ground member is configured to apply a force to multiple cables terminated to a cable termination assembly, the upper ground member may have multiple concave portions separated by flanges for attachment to other ground structures.

Ground member 954 optionally may include features for connection to a ground structure of the paddle card to which the cable termination assembly is mounted. The connection may be made through the ground terminals of the cable termination assembly, in some examples. In the example of FIG. 9, ground member 954 includes arms, of which arms 956A and 956B are numbered, that may be connected to a ground terminal near the mounting end of the ground terminal. Arms 956A and 956B, for example, may be soldered to a ground terminal. Ground member 954 may have similar arms (not numbered) on an opposite side to enable ground member 954 to be connected to ground terminals adjacent to and on both sides of the signal terminals terminated to a cable within the concave portion 958 of ground member 954. Accordingly, each of ground members 954 may provide a ground current path from the cable shield, through the ground member 954 and into the ground structure of the paddle card to which the cable termination assembly is mounted, by passing through arms 956A or 956B and into the paddle card through the mounting ends of one or more ground terminals.

An upper ground member, such as ground member 954 may alternatively or additionally include features other than solder to hold the ground member to the cable termination assembly. An upper ground member, for example, may be attached to a housing of the cable termination assembly with a segment of a cable with an exposed shield between the upper ground member and one or more other ground structures associated with the cable termination assembly. The housing of the cable termination assembly and ground member 954, for example, may have complementary engagement features. In the example of FIG. 9A, the housing of the cable termination assembly 212A includes hubs 972 and ground member 954 includes holes 970. Ground member 954 may be held in place, for example, by pressing ground member 954 against the housing such that hubs 972 pass through holes 970. The hub and hole may form an interference fit, for example. As another example, ground member 954 may be held against the housing by heat staking, which may include deforming a portion of hubs 972 extending through holes 970 to prevent ground member 954 from being moved away from the terminal subassembly. Such attachment features may be used to secure ground member 954 in a position in which it applies force to the cable 214 instead of or in addition to one or more of the solder locations described herein.

Also as shown, a ground member alternatively or additionally may include a slot, such as slot 974, to receive a portion of the housing when the ground member is mounted to the cable termination assembly. Such a slot may aid in engagement of the ground member to the housing and/or enable the housing to be made sufficiently rugged to support attachment.

FIG. 9B illustrates an alternative implementation of a ground member 954′ in a cable termination assembly that otherwise has the characteristics described in connection with FIG. 9B. In this example, a single larger hub 972′ is shown engaging a single larger hole 970′ Moreover, a slot 974′ is larger, extending up the side and partially into the top of concave portion 958. In contrast, slot 974 extends up the side concave portion 958, but ends before the top. In some scenarios, the smaller holes 970 and smaller slot 974 of the example of FIG. 9A may provide better electrical performance.

FIG. 10 is an isometric view of the exemplary cable termination assembly 212A of FIG. 8, in a state of manufacture in which signal conductors of one of multiple cables 214 have been terminated to the cable termination assembly. In this view, mounting ends of a row of terminals 352 are visible. The exemplary cable termination assembly 212A may include a set of holes 1015. The holes may correspond to locations in which solder is dispensed, such as to solder a ground member 952 to the ground strip and/or a ground terminal of the cable termination assembly.

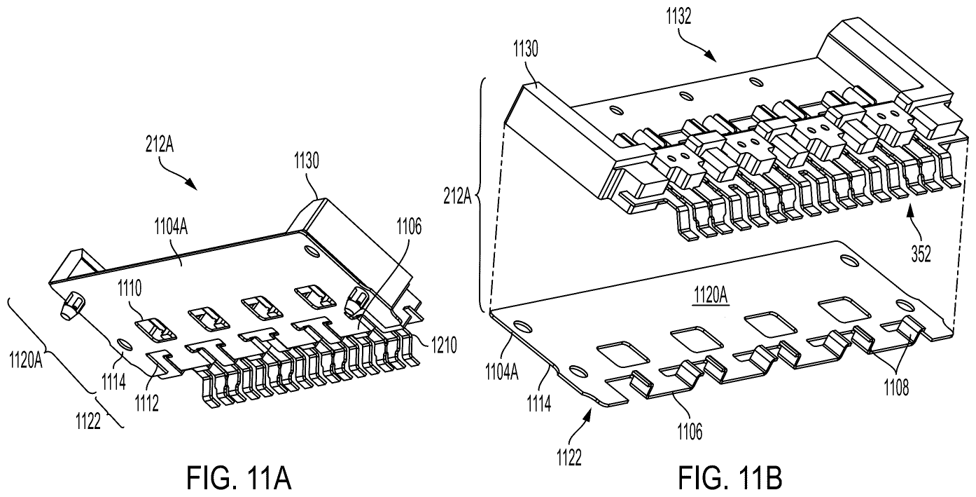

FIG. 11A is an isometric view from the lower left side of the exemplary cable termination assembly 212A of FIG. 8, in a state of manufacture in which a lower ground member 1104A has been attached. FIG. 11B is an isometric view from the lower left side of the exemplary cable termination assembly 212A of FIG. 11A, in a state of manufacture prior to attachment of the lower ground member 1104A. In the example of FIGS. 11A and 11B, cable termination assembly 212A has a housing, formed by insulator 1130 and terminals, with mounting ends 352 extending from the housing. The insulator 1130 may form a cavity 1132 and the wire connecting ends of the plurality of signal terminals may be disposed in the cavity.

FIG. 12 is an isometric view of a an exemplary leadframe 1210 of the exemplary cable termination assembly of FIG. 8. FIG. 12 provides details of the terminals within the housing of cable termination assembly 212A, as shown in FIGS. 11A and 11B. The leadframe 1210 has multiple conductive structures that are aligned edge to edge at least over a portion of their length. In this example, those conductive structures are signal terminals 1252, ground terminals 1262 and 1264 and ground strip 1262A. Such a structure may be created by stamping the conductive structures from a planar sheet of metal and bending portions of the stamped structure out of the plane of the sheet. In some cases, the conductive structures may initially be held together by tie bars. Insulative material may be molded over the conductive structures and the tie bars may then be severed, to electrically isolate the conductive structures. In some examples, the stamping operation may leave a portion of the metal sheet encircling the conductive structures, having the appearance of a frame. That frame may be removed when the tie bars are severed. However, it is not a requirement that conductive structures, even if referred to as a leadframe, be manufactured according to a stamping operation that produces a frame.

Each of the plurality of signal terminals 1252 may comprise a mounting end 1252B configured for mounting to a surface of a substrate. In this example, the mounting ends 1252B are configured for surface mount soldering and may have a J-lead configuration. Each of the plurality of signal terminals 1252 may also comprise wire connecting end 1252A configured for terminating a wire of a cable. As can be seen, each of the

Leadframe 1210 may further include a plurality of ground terminals 1262 and 1264 held within the insulative housing. In the example of FIG. 12, the ground terminals 1262 between pairs of signal terminals 1252 are shaped differently than the ground terminals 1264 at the end of the row to terminals. The ground terminals 1262, for example, may be wide enough for two upper ground members 954, one at least partially surrounding the signal conductors on each side of the ground terminal 1264, to be attached. Each of the plurality of ground terminals may comprise a mounting end 1262B or 1264B configured for mounting to the surface of the substrate. At an opposite end, the ground terminals 1262 and 1264 may be connected to a ground strip 1262A.

As described above, ground terminals 1262 and 1264 may be connected to the ground structure of the cables terminated to the cable termination assembly 212A by pressing those ground structures against the ground strip 1262A and/or ground terminals 1262 and 1264. The cable connection ends of the ground structures may be flat, or in some examples may have other shapes such as concave portions, to support such attachment. A different attachment technique may be used for attaching the signal terminals to the conductors of the cables, and the wire connecting ends of the signal terminals may be configured to support the attachment technique used. In the illustrated example, the wire connecting ends 1252A of the signal terminals 1252 may include wings 1254, bent relative to the broadsides of the signal terminals to facilitate soldering or welding, for example.

In the example of FIG. 12, the mounting ends of the signal and ground terminals are aligned in a plane, which may support surface mount attachment. The cable connecting ends for signal and ground terminals, however, may be in different planes. The relative position of the cable connecting ends for signal and ground terminals may be configured such that, when a cable end is prepared for termination as shown in FIG. 10, the cable connecting ends for the signal terminals will align with the when the cables are placed with the ground shields of the cables aligned with the cable connecting ends of the ground terminals and/or ground strip 1262A the signal conductors 1022 of the cable will align with the broadsides of the will align with the wire connecting ends of the signal conductors. Such an arrangement may be achieved with jogs of different sizes in the signal and ground terminals. Signal terminals, for example, may have jogs 1258 and ground terminals may have jogs 1260. Jogs 1260 are larger than jogs 1258 in the illustrated example. Jogs 1258, for example, may displace the plane of the wire connecting ends of the signal terminal by an amount approximating the diameter of the wire of the cable, such as the diameter of a 28 AWG wire or larger diameter wire. In contrast, jogs 1260 may displace the plane of the wire connecting ends of the ground terminals by that amount plus the thickness of the insulator of the cable 214. Such a configuration may shape the ground current paths through the connector and contribute to signal integrity sufficient to support very high-speed signals, as described herein.

Leadframe 1210 may also include tabs 1266 for mechanical stability after insert molding a housing over the leadframe. These features act as anchors to retain leadframe 1210 inside the housing to form a stable leadframe assembly. The housing may be molded over intermediate portions 1256 of the terminals, leaving the mounting ends and the cable connection ends of signal terminals and ground terminals exposed.

FIG. 12 in combination with FIGS. 11A and 11B illustrate mounting of a lower ground member, here illustrated as ground member 1104A to the cable termination assembly 212A. Ground member 1104A may be stamped from a sheet of metal and formed with structures, as shown. The ground member 1104A may comprise a plurality of mounting portions 1106 configured for mounting to the surface of the substrate. The mounting ends of the plurality of signal terminals and the plurality of ground terminals on the cable termination assembly 212a may be co-planar with the mounting portions of the ground member 1104A. Such a configuration may enable ground member 1104A to be surface mount soldered to at least one ground pad on the surface of the substrate in the same operation in which the mounting ends of the signal terminals and ground terminals are mounted.

Mounting portions 1106, for example, may be attached to ground pads 623b in footprint 610A (FIG. 6), for example, whereas the signal and ground terminals may be attached to the signal pads 613a and ground pads 613b within the same footprint. In this example, ground member 1104A includes side portions 1114 that are in the same plane as mounting portions 1106. The side portions 1114 may also be attached to one or more ground pads on the surface of the paddle card 211. Side portions 1114 may be surface mount soldered, for example, to ground pads 633b in footprint 610A.

Ground member 1104A may be attached to other conductive structures associated with cable termination assembly 212A. The shape of ground member 1104A and/or mechanism and location of attachment to the ground conductors within the cable termination assembly 212A may form ground paths that promote the high signal integrity to support high-speed operation of a connector.

In the example illustrated, ground member 1104A may further comprise structures for connection to ground terminals 1262 and 1264. Those connections may be made at the end of ground member 1104A near the mounting ends, which is opposite the end at which ground member 1104A is coupled to the cable ground structures. In this example, those structures are wings 1108 that extend from the mounting portions Each of the wings 1108 may be attached to a respective ground terminal of the plurality of ground terminals 1262 of the cable termination assembly 212a. Each of the wings 1108 extending from the mounting portions of the ground member 1104A may be attached to the respective ground terminal of the plurality of ground terminals 1262 at the mounting end 1262B of the respective ground terminal of the cable termination assembly 212a. This attachment may be made, for example, by welding. 1106. Each mounting portion 1106 and its associated wings 1108 may form a concave structure that partially encircles signal terminals between ground terminals to which the wings are attached.

In the example illustrated, ground member 1104A may further be connected to the ground structures of the cable termination assembly 212A at an end opposite the mounting ends of the ground terminals 1262. As described above, the cable shields may be connected at ground strip 1262A and ground member 1104A may be connected to the cable grounds indirectly through ground strip 1262A. Ground member 1104A may be welded to ground strip 1262A, for example. In the illustrated example, ground member 1104A may have a planar portion affixed to the ground strip 1262A of the cable termination assembly 212A. That planar portion will be parallel to the ends of the cables terminated to cable termination assembly 212A.

In the example illustrated, the plurality of mounting portions 1106 on the ground member 1104A are disposed in a plane. That plane may be parallel to a face of the cable termination assembly configured for mounting against a substrate. For a cable termination assembly configured to receive terminated ends of cables in a plane parallel to the substrate, such as cable termination assembly 212A, the plane containing mounting portions 1106 may be substantially parallel to the plane of ground strip 1262A, against which those cables may rest. Accordingly, the plane containing mounting portions 1106 may be at an angle within the range of +/−5 degrees with respect to the ground strip 1262A on the cable termination assembly 212a.

The planar portion 1120 of the ground member 1104A may be attached, such as by welding to ground strip 1262A, and may have the same orientation as ground strip 1262A with respect to structures for mounting to the substrate. The ground member 1104A, for example, may also have one or more side portions 1114, which may be configured for mounting to the surface of the substrate. The side portion 1114 may be at an angle within the range of +/−5 degrees with respect to the planar portion 1120 of the ground member 1104A, as shown in the example of cable termination assembly 212A.

The side portion 1114 of the ground member 1104A alternatively or additionally may be at an angle within the range of +/−5 degrees with respect to the planar portion 1120 of the ground member 1104A.

Optionally, the ground member 1104A may include one or more openings, examples of which are shown in FIGS. 11A and 11B as openings 1110 and 1112., Some or all of these openings may provide impedance control such that the impedance of the signal paths vary by less than, for example, +/−5%, and in some examples less than +/−3% along signal paths from cable to paddled card through the cable termination assembly. Openings 1110, for example, may be aligned with the wire connecting ends of the signal terminals. Openings 1112 may provide impedance control and/or shape ground current to enhance signal integrity such as by reducing crosstalk through a reduction in mode conversion. In this example, openings 1112 are between adjacent mounting portions 1106, each of which is aligned with the one or more signal conductors (a pair in this example) between adjacent ground terminals.

In the example illustrated, each of the cable termination assemblies 212A and 212B has a mounting region and a planar portion. FIGS. 11A and 11B, for example, show a planar portion 1120A and a mounting region 1122 in a cable termination assembly 212A. Mounting region 1122 includes the mounting portions 1106 and side portions 1114 with the planar portion 1120A parallel to the ends of the cables terminated to the cable termination assembly. Accordingly, in the example of cable termination assembly 212A planar portion 1120A and mounting region 1122 are substantially parallel. In this example, they are coplanar.

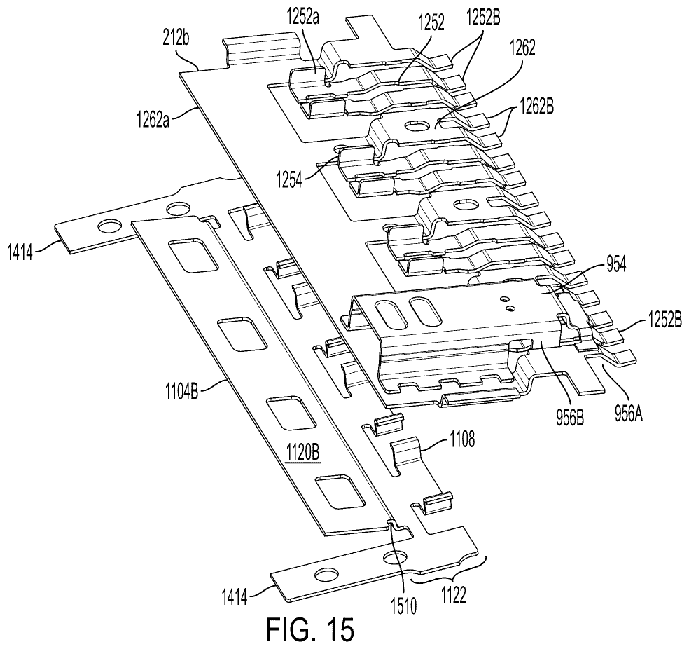

In the example of cable termination 212B, which in this case is configured for leapfrog mounting, a lower ground member 1104B may have a mounting region 1122 disposed in a plane at an acute angle, which may be greater than 5 degrees for example, with respect to the planar portion 1120B. Such a configuration may be created by a bend 1510 (FIG. 15) in ground member 1104B between mounting region 1122 and planar portion 1120B. Such a configuration may support termination with high signal integrity even at high frequencies of cables arriving at cable termination assembly 212B at an acute angle with respect to the substrate. To support such a configuration, a lead assembly used to form cable termination assembly 212B may be formed with a greater angle between the mounting ends and intermediate portions of the terminals of the lead assembly. The housing molded over the leadframe may be adjusted for this difference, but the construction of a cable termination assembly and its associated upper and lower ground members may otherwise be as described in connection with cable termination assembly 212A. In this way, the electrical characteristics of each of the cable termination assemblies may be substantially the same, and both may provide high signal integrity signal paths even at high frequencies to support data rates up to at least 224 Gbps.

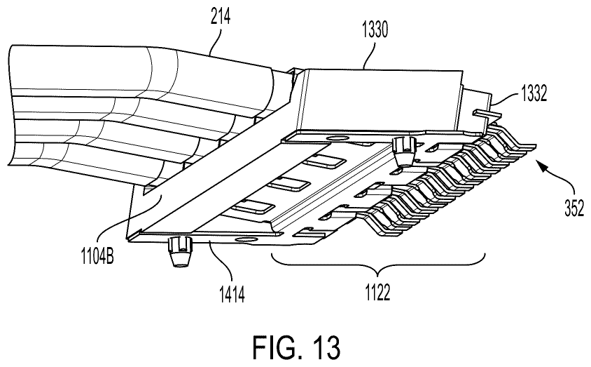

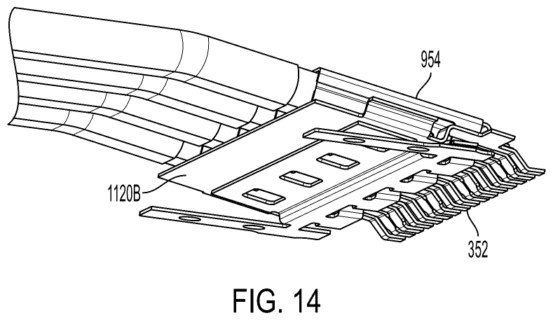

FIG. 13 is an isometric view of cables connected to an exemplary cable termination assembly 212B configured for a leapfrog connection in the exemplary cable connection assembly of FIG. 4. FIG. 14 is an isometric view of cables connected to the exemplary cable termination assembly of FIG. 13, with an insulative housing of the cable termination assembly cutaway. In these views, the angle between planar portion 1120B and mounting region 1122 is visible.

Also visible in FIG. 13 is the angle of side wall 1332 of housing 1330 with respect to the plane of the mounting region 1122. In this example, side wall 1332 is a forward sidewall near the mounting ends of the terminals of cable termination assembly 212B. The angle in this example is less than 90 degrees. Such an angle orients side wall 1332 substantially perpendicular to the plane of the terminals as they exit the housing 1330. Such an angle optionally may be used to simplify manufacture of the cable termination assembly 212B via insert molding. An opposing, rear sidewall (not numbered) may be parallel side wall 1332, as in the example pictured.

Ground structures in the vicinity of the signal paths may otherwise be formed as described above in connection with cable termination assembly 212A. A concave portion of a ground member 954, for example, may be positioned over the ends of cables 214 to urge them toward the cable termination assembly. The exemplary cable termination assembly 212B may also include mounting ends of a row of terminals 352. As shown in FIGS. 13 and 14, the subassembly may further include a bottom ground member 1104B having side portion 1414. These structures may be mounted to footprint 610B (FIG. 6), for example, using any of the ways described above for mounting corresponding structures of cable termination assembly 212A to footprint 610A. Conversely, any of the details of construction revealed in FIGS. 13-15 in connection with cable termination assembly 212B may apply to cable termination assembly 212A.

FIG. 15 is a partially exploded isometric view of the exemplary cable termination assembly of FIG. 14, with a lower ground member 1104B and one upper ground member 954, but without cables attached. As pictured in FIG. 15, cable termination assembly 212B may comprise a plurality of signal terminals 1252, which may be held within an insulative housing (not pictured in FIG. 15). Each of the plurality of signal terminals may comprise a mounting end configured for mounting to a surface of a substrate and a wire connecting end 1252A. The cable termination assembly 212B may further include a plurality of ground terminals 1262 held within the insulative housing. Each of the plurality of ground terminals may comprise a mounting end 1262B configured for mounting to the surface of a substrate.

The subassembly for the cable connector of FIG. 15 may further comprise a ground member 1104B, which may be mounted to the cable termination assembly 212B. The ground member 1104B may comprise a mounting region 1122. The plurality of signal terminals 1252 and the plurality of ground terminals 1262 of the cable termination assembly 212B may be held by the housing in a row with signal terminals of the plurality of signal terminals 1252 disposed between ground terminals of the plurality of ground terminals 1262.

In some embodiments, the ground member 1104B may further comprise wings 1108 that may extend from the mounting portions. Each of the wings 1108 may be attached to a respective ground terminal of the plurality of ground terminals 1262 of the cable termination assembly 212B. Each of the wings 1108 extending from the mounting portions of the ground member 1104B may be attached to the respective ground terminal of the plurality of ground terminals 1262 at the mounting end 1262B of the respective ground terminal of the cable termination assembly 212B.

In some embodiments, the cable termination assembly 212B may further comprise a ground strip 1262A connecting the plurality of ground terminals 1262 at an end opposite the mounting ends of the ground terminals 1262. The ground member 1104B may have a planar portion affixed to the ground strip 1262A of the cable termination assembly 212B.

In some embodiments, the mounting region 1122 on the ground member 1104B may be disposed in a plane. The plane may be at an angle greater than 5 degrees with respect to the ground strip 1262A on the cable termination assembly 212B. The ground member 1104B may also have a side portion 1414, which may be configured for mounting to the surface of a substrate. The side portion 1414 may be at an angle greater than 5 degrees with respect to the planar portion 1120B of the ground member 1104B. The mounting portions 1106 of the ground member 1104B may be disposed in a plane at an angle greater than 5 degrees with respect to the ground strip 1262A of the cable termination assembly 212B.

In some embodiments, the ground member 1104B may have a side portion 1114, which may be configured for mounting to the surface of the substrate (211). The side portion 1114 of the ground member 1104B may be at an angle greater than 5 degrees with respect to the planar portion 1120B of the ground member 1104B. The wire connecting end 1252A of each of the plurality of signal terminals 1252 on the cable termination assembly may comprise a wing 1254 configured for soldering a wire of a cable thereto.

Cable connectors as described herein may be simply manufactured in a way that provides stable and repeatable high signal integrity signal paths. Initially, a cable termination assembly may be formed by stamping leadframes, as described above for cable termination assembly 212A or 212B. These leadframes may be overmolded with insulator, leaving the terminals exposed at both the mounting end and wire attachment ends. The resulting cable termination assemblies may each have a lead frame and an insulative housing holding a plurality of signal terminals and a plurality of ground terminals disposed in a row with ground terminals of the plurality of ground terminals bounding pairs of the plurality of signal terminals. A first ground member (1104A or 1104B) may then be attached to a first cable termination assembly (212a). The first ground member may be a lower ground member, configurated for mounting between the cable termination assembly and a substrate. Attachment may be achieved, for example, by welding. Other attachment features may alternatively or additionally be used. Portions of the housing, for example, may extend through openings in the first ground member to hold it in place against the housing.

One or more such cable termination assemblies with an attached ground members may be attached to a substrate to form a cable connection assembly. The combined structure, for example, may be mounted to a first side of a substrate (211), wherein the first side of the substrate comprises a plurality of signal pads and at least one ground pad. In some embodiments, the mounting comprises: soldering mounting ends of the plurality of signal terminals of the first cable termination assembly to respective signal pads of the plurality of signal pads on the first side of the substrate (211) and soldering mounting ends of the plurality of ground terminals of the first cable termination assembly to the at least one ground pad of the substrate. This soldering may be performed in a single reflow operation.

If multiple cable terminations assemblies are attached, they may have different configurations. The first ground member of the first cable termination assembly, for example, may be substantially parallel to the substrate (see e.g., FIG. 4). A first ground member of a second cable termination assembly may form an acute angle with the substrate (see e.g., FIG. 4).

Regardless of the number and configurations of the cable termination assemblies in the cable connection assembly, cables may be terminated to the cable connection assembly. A set of cables, comprising a plurality of cables, may be terminated to each cable termination assembly. Wires of each of a plurality of cables may be attached to respective wire connecting ends of the plurality of signal terminals of each cable termination assembly Optionally, fusing of the wire comprises soldering the wire of the first cable to the wire connecting end of the at least one signal terminal of the first cable termination assembly. Shields of each of the plurality of cables of a set may be coupled to at least one ground terminal of a respective cable termination assembly.

In some embodiment, the method may further comprise positioning concave portions of at least one ground member (954) over the ends of the first plurality of cables fused to the wire connecting ends of the plurality of signal terminals of the first cable termination assembly. Optionally, each of the at least one ground members may have one concave portion such that separate ground members may be mounted over each of the terminated cables. The ground members, therefore, may be separately aligned with each cable and then attached directly or indirectly to the ground terminals of the cable termination assembly. Attachment, for example, may be via solder. Soldering may urge the first plurality of cables toward the first cable termination assembly, which may press an exposed portion of the cable shield against a ground structure of the cable termination assembly. In some examples, a cable connector may be constructed by electrically coupling the shields of the plurality of cables to the plurality of upper ground members. Optionally, the method may further comprise: positioning the first ground member and these upper ground members to provide a plurality of ground paths between the cable shields and the ground structures of the substrate controlling an insertion loss and a return loss sufficiently to support conduction of high frequency signals.

Optionally, multiple cable termination assemblies, including one or more leapfrog cable termination assemblies as described above, may be mounted to the same side of the substrate in the same reflow operation. If multiple cable termination assemblies are mounted on a substrate, this cable termination process may be repeated for each of the cable termination assemblies.

Prior to terminating cables to each of one or more cable termination assemblies, the cables may be prepared for termination. Preparation may include stripping away portions of the cables to leave exposed wires and a segment with an exposed cable shield. Further, the groups of cables to be terminated to each of the cable termination assemblies may be separated from a cable bundle, if necessary, and aligned. Each set of cable terminated to a cable termination assembly may be aligned in a plane. Optionally, the method may further comprise molding a cable positioning member (216) over the first plurality of cables to sets of cables for termination to respective cable termination assemblies.

The resulting cable connection assembly, along with the cable positioning member, if present, may be enclosed in a connector housing, to complete a cable assembly.

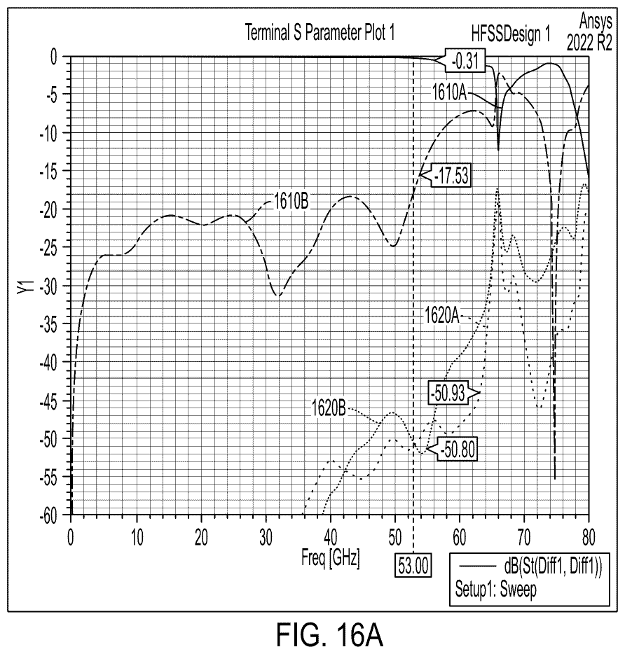

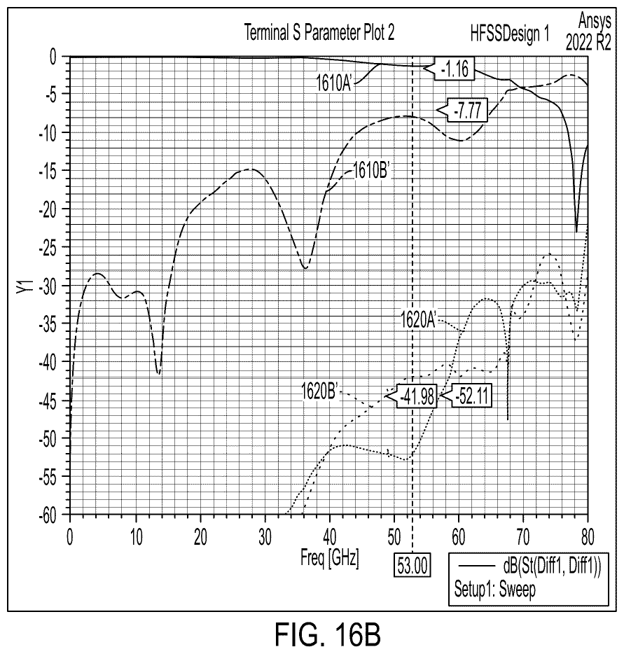

FIG. 16A is an S Parameter Plot showing simulated insertion loss and return loss on two signal paths through a cable termination assembly configured for a straight connection and a cable termination assembly configured for a leapfrog connection, respectively using techniques as described herein, including a ground cover as shown in FIG. 9A. The plot of FIG. 16A illustrates an insertion loss and return loss sufficient to enable high frequency signals to pass with sufficiently high signal integrity to support data rates of at least 224 Gbps. More particularly, traces 1610A and 1610B illustrate insertion loss vs frequency. Traces 1620A and 1620B show the return loss vs frequency. Significantly, the insertion loss is below 3 dB and even below 1 dB up to a frequency of 53 GHz and the return loss is substantially below −10 dB.

FIG. 16B is an S Parameter Plot showing simulated insertion loss and return loss on two signal paths through a cable termination assembly configured for a straight connection and a cable termination assembly configured for a leapfrog connection, respectively using techniques as described herein, including a ground cover as shown in FIG. 9B. The plot of FIG. 16B illustrates an insertion loss and return loss sufficient to enable high frequency signals to pass with sufficiently high signal integrity to support data rates of at least 224 Gbps. More particularly, traces 1610A′ and 1610B′ illustrate insertion loss vs frequency. Traces 1620A′ and 1620B′ show the return loss vs frequency. Significantly, the insertion loss is below 3 dB, and is approximately 1 dB up to a frequency of 53 GHz and the return loss is substantially below −10 dB.

In contrast, conventional termination techniques in which cables were terminated directly to a paddle card could not achieve these levels of insertion or return loss at frequencies significantly above 10 GHz, limiting the useful operating frequency range to about 15 GHz, for example. The graphs show that ground paths resulting from one or a combination of the techniques described herein may result in a cable assembly with return loss through the connector of less than −10 dB and insertion loss below 3 dB, and in some examples below 1 dB at frequencies up to at least 53 GHz, which provides signal integrity adequate to support signals beyond 212 Gbps (PAM4), including up to 224 Gbps or higher.

Crosstalk between signal in a connector are shown to be similarly low. For example, multiactive crosstalk was simulated to be below −5 dB for frequencies up to and above 53 GHz, such as less than −6 dB or −7 dB of far end cross talk up to at last 53 GHz.

### EXAMPLES

In one example, a subassembly for a cable connector may comprise a cable termination assembly, which may comprise: an insulative housing; a plurality of signal terminals held within the insulative housing, each of the plurality of signal terminals comprising a mounting end configured for mounting to a surface of a substrate and a wire connecting end; a plurality of ground terminals held within the insulative housing, each of the plurality of ground terminals comprising a mounting end configured for mounting to the surface of the substrate. The subassembly may also comprise a ground member mounted to the cable termination assembly comprising a plurality of mounting portions configured for mounting to the surface of the substrate.

Such a subassembly may optionally comprise one or more of the following features:

The mounting ends of the plurality of signal terminals and the plurality of ground terminals may be co-planar with the mounting portions of the ground member;

The plurality of signal terminals and the plurality of ground terminals are held by the housing in a row with signal terminals of the plurality of signal terminals disposed between ground terminals of the plurality of ground terminals.

The ground member further comprises wings extending from the mounting portions; and each of the wings is attached to a respective ground terminal of the plurality of ground terminals.

Each of the wings may be attached to the respective ground terminal of the plurality of ground terminals at the mounting end of the respective ground terminal.

The cable termination assembly may further comprise a ground strip connecting the plurality of ground terminals at an end opposite the mounting ends of the ground terminals.

The ground member may have a planar portion affixed to the ground strip.

The plurality of mounting portions may be disposed in a plane; and the plane may be at an angle within the range of +/−5 degrees with respect to the ground strip.

The ground member may have a side portion configured for mounting to the surface of the substrate; and the side portion may be at an angle within the range of +/−5 degrees with respect to the planar portion.

The plane may be at an angle greater than 5 degrees with respect to the ground strip.

The ground member has a side portion configured for mounting to the surface of the substrate; and the side portion may be at an angle within the range of +/−5 degrees with respect to the planar portion.

The wire connecting end of each of the plurality of signal terminals may comprise a wing configured for soldering a wire of a cable thereto.

In another example, a cable connection assembly may comprise a first cable termination assembly, which may comprise: a first plurality of signal terminals, each of the first plurality of signal terminals comprising a mounting end and a wire connecting end; and a first plurality of ground terminals, each of the first plurality of ground terminals comprising a mounting end; a first ground member coupled to the first cable termination assembly and comprising a plurality of mounting portions; and a substrate having a first side. The first side may comprise: a first plurality of signal pads; and at least one ground pad. The mounting ends of the first plurality of signal terminals may be coupled to respective pads of the first plurality of signal pads, and the mounting ends of the plurality of ground terminals and the mounting portions of the ground member are each coupled to a ground pad of the at least one ground pad.

Such a cable connection assembly may optionally comprise one or more of the following features:

The first plurality of signal terminals and the first plurality of ground terminals may be disposed in a row with signal terminals of the first plurality of signal terminals disposed between ground terminals of the first plurality of ground terminals.

The first ground member may comprise wings extending from the mounting portions; and each of the wings may be attached to a respective ground terminal of the first plurality of ground terminals.

Each of the wings may be attached to the respective ground terminal of the first plurality of ground terminals at the mounting end of the respective ground terminal.

The wings of the first ground member may be attached to the respective ground terminal of the first plurality of ground terminals via welding.

The first cable termination assembly may further comprise a first ground strip connecting the first plurality of ground terminals at a cable termination end opposite the mounting end.

The first ground member may have a planar portion affixed to the first ground strip.

The planar portion may be welded to the first ground strip.

The plurality of mounting portions of the first ground member may be disposed in a plane, and the plane may be at an angle within the range of +/−5 degrees with respect to the planar portion.

The first ground member may be soldered to the first cable termination assembly.

A second cable termination assembly may comprise a second plurality of signal terminals, each of the second plurality of signal terminals comprising a mounting end and a wire connecting end; and a second plurality of ground terminals, each of the second plurality of ground terminals comprising a mounting end. A second ground member may be coupled to the second cable termination assembly and comprise a plurality of mounting portions. The substrate may further comprise a second plurality of signal pads; the mounting ends of the second plurality of signal terminals may be coupled to respective pads of the second plurality of signal pads, and the mounting ends of the second plurality of ground terminals and the mounting portions of the second ground member may each be coupled to a ground pad of the at least one ground pad.

The first cable termination assembly may comprise a first cavity to receive ends of a first plurality of cables for termination to the first cable termination assembly, the first cavity having a first floor; the second cable termination assembly may comprise a second cavity to receive ends of a second plurality of cables for termination to the second cable termination assembly, the second cavity having a second floor; and the first floor may be at a first angle with respect to the surface of the substrate and the second floor may be at a second angle with respect to the surface of the substrate that is greater than the first angle.

A planar portion of the first ground member may be parallel to the floor of the first cavity; and a planar portion of the second ground member may be parallel to the floor of the second cavity.

The wire connecting ends of the first plurality of signal terminals may extend into the first cavity and are parallel to the first floor; and the wire connecting ends of the second plurality of signal terminals may extend into the second cavity and are parallel to the second floor.

The substrate may comprise a plurality of contact pads disposed parallel and adjacent to a first edge; the substrate may comprise a second edge opposite the first edge; the first cable termination assembly may be mounted closer to the second edge than the second cable termination assembly.

The first plurality of signal pads may extend in a first row, parallel to the first edge; and the second plurality of signal pads may extend in a second row, parallel to the first row.

The at least one ground pad may comprise: a first plurality of ground pads within the first row; a second plurality of ground pads within the second row; a third plurality of ground pads in a third row parallel to the first row and between the first row and the second row; and a fourth plurality of ground pads in a fourth row parallel to the second row and between the second row and the second edge. The first plurality of ground terminals may be mounted to the first plurality of ground pads; the second plurality of ground terminals may be mounted to the second plurality of ground pads; mounting portions of the first ground member may be mounted to the third plurality of ground pads; and the mounting portions of the second ground member may be mounted to the fourth plurality of ground pads.

The substrate may comprise a side extending between the first edge and the second edge; the at least one ground pad may further comprise: a first elongated ground pad, elongated in a direction parallel to the side; a second elongated ground pad, elongated in the direction parallel to the side. The first ground member may comprise a side portion mounted to the first elongated ground pad; and the second ground member may comprise a side portion mounted to the second elongated ground pad.

The first cable termination assembly may comprise a first insulative housing holding the first plurality of signal terminals and the first plurality of ground terminals; the second cable termination assembly may comprise a second insulative housing holding the second plurality of signal terminals and the second plurality of ground terminals; the first insulative housing may have a first bottom, parallel to the first side of the substrate, and a first forward wall with the mounting ends of the first plurality of signal terminals and the first plurality of ground terminals extending therethrough; the first forward wall may be perpendicular to the first bottom; the second insulative housing may have a second bottom, parallel to the first side of the substrate, and a second forward wall with the mounting ends of the second plurality of signal terminals and the second plurality of ground terminals extending therethrough; the second forward wall may be at an angle between 45 and 85 degrees with respect to the second bottom.

The substrate may have a second side opposite the first side. The cable connection assembly may further comprise: a third cable termination assembly, configured like the first cable termination assembly, mounted to the second side; and a fourth cable termination assembly configured like the first cable termination assembly, mounted to the second side.

The substrate may be a paddle card.

In another example, a cable connector may comprise: an outer housing comprising a cavity; a cable connection assembly disposed within the cavity. The cable connection assembly may comprise: a substrate having a first side. The first side may comprise: a plurality of signal pads; and at least one ground pad; at least one cable termination assembly mounted to the first side of the substrate. Each cable termination assembly of the at least one cable termination assembly may comprise: a plurality of signal terminals, each of the plurality of signal terminals may comprise a mounting end and a wire connecting end; and a plurality of ground terminals. Each of the plurality of ground terminals may comprise a mounting end; and at least one ground member coupled to a respective cable termination assembly of the at least one cable termination assembly. The mounting ends of the plurality of signal terminals may be coupled to respective pads of the plurality of signal pads; the mounting ends of the plurality of ground terminals may be coupled to the at least one ground pad; and for each of the at least one ground members, the ground member may be attached to ground terminals of the plurality of ground terminals of a respective cable termination assembly and the at least one ground pad.

Such a cable connector may optionally comprise one or more of the following features:

Each cable termination assembly of the at least one cable termination assembly may further comprise a ground strip connecting the plurality of ground terminals; and a ground member of the at least one ground member may be attached to the ground strip.

The ground member may be attached to the ground strip via a weld; the ground member may be attached to the plurality of ground terminals via welds; and the ground member may be attached to the least one ground pad via solder.

A cable positioning member may be disposed within the cavity.

The substrate may be a paddle card.

At least one ground pad may be a plurality of ground pads.

The at least one cable termination assembly may comprise a first cable termination assembly and a second cable termination assembly; the first cable termination assembly may be configured to receive a first plurality of cables routed to the first cable termination assembly at a first angle with respect to the substrate; the second cable termination assembly may be configured to receive a second plurality of cables routed to the second cable termination assembly at a second angle with respect to the substrate; and the second angle may be larger than the first angle.

The substrate may have a second side opposite the first side. The second side may comprise: a second plurality of signal pads and at least one second ground pad.

A third cable termination assembly and a fourth cable termination assembly may be mounted to the second side of the substrate.

A third plurality of signal terminals, each of the third plurality of signal terminals may comprise a mounting end and a wire connecting end; and a third plurality of ground terminals, each of the third plurality of ground terminals may comprise a mounting end; the mounting ends of the third plurality of signal terminals may be coupled to respective pads of the second plurality of signal pads and the mounting ends of the plurality of ground terminals of the third cable termination assembly may be coupled to the at least one second ground pad.

The mounting end of the third plurality of signal terminals on the third cable termination assembly may be soldered to respective signal pads of the third plurality of signal pads; and the mounting ends of the third plurality of ground terminals on the third cable termination assembly may be soldered to the at least one ground pad on the second side of the substrate.

The substrate may comprise a second side, opposite the first side; the substrate may comprise a plurality of contact pads at a front of the substrate; the plurality of signal pads may be a first plurality of signal pads; the first plurality of signal pads may be arranged in a first row and a second row at a rear of the substrate, opposite the front of the substrate; the front of the substrate may be exposed through the outer housing; the cables may enter the outer housing from the rear; each of the cables may comprise at least one conductor terminated to a signal terminal of the plurality of signal terminals of a cable termination assembly of the at least one cable termination assembly; each of the cables may comprise a shield and a segment with the shield exposed; for each of the at least one cable termination assemblies, a respective plurality of the cables may be terminated to the cable termination assembly, with the segments of the cables of the respective plurality of cables with exposed shields aligned in a plane; and for each of the at least one ground members, the ground member may have a portion substantially parallel to the plane of the segments of the plurality cables terminated to the respective cable termination assembly in which the shields of the plurality of cables are exposed.

The at least one cable termination assembly may comprise a first cable termination assembly mounted to the first side of the substrate, a second cable termination assembly mounted to the first side of the substrate, a third cable termination assembly mounted to the second side of the substrate, and a fourth cable termination assembly mounted to the second side of the substrate.

The first cable termination assembly may be mounted to the first side of the substrate to the rear of the second cable termination assembly; and the third cable termination assembly may be mounted to the second side of the substrate to the rear of the fourth cable termination assembly.

The respective plurality of the cables for the second cable termination assembly may pass over the first cable termination assembly; the respective plurality of the cables for the fourth cable termination assembly may pass over the third cable termination assembly; and the plane of the segments of the plurality of cables of the second plurality of cables may be at an angle with respect to the first surface of the substrate that is greater than the angle of the plane of the segments of the plurality of cables of the first plurality of cables.

At least one upper ground member may be electrically and mechanically coupled to the exposed shields of the respective plurality of cables and to the plurality of ground terminals of the respective cable termination assembly.

The at least one upper ground member for each of the plurality of cable termination assemblies may comprise an upper ground member for each of the respective plurality of cables.

Each of the at least one cable termination assemblies may further comprise an insulator holding the plurality signal terminals; and for each of the at least one cable termination assemblies, the insulator may comprise a cavity with the wire connecting ends of the plurality of signal terminals disposed in the cavity.

For each of the at least one cable termination assemblies, each of the at least one ground members may be attached to the ground strip.

For each of the at least one cable termination assemblies, the segments of the respective plurality of cables with exposed shields may be disposed within the cavity.

A ground member of the at least on ground members may be attached to a respective leadframe of a cable termination assembly of the at least one cable termination assemblies. The plurality of ground terminals and the ground strip may comprise a leadframe; the segments of the respective plurality of cables with exposed shields may be held between the leadframe and the at least one upper ground member.

For each of the at least one cable termination assemblies, the at least one upper ground members may urge segments of the respective plurality of cables toward the cable termination assembly.

For each of the at least one cable termination assemblies, the at least one upper ground members may comprise at least one concave portion contact the segments of the respective plurality of cables; for a first subset of the at least one cable termination assemblies, the concave portion of the at least one upper ground members may be elongated in a direction substantially parallel to the substrate; and for a second subset of the at least one cable termination assemblies, the concave portion of the at least one upper ground members may be elongated in a direction at an angle of 5 to 45 with respect to the substrate.

For each of the at least one cable termination assemblies, the at least one ground members may comprise a planar portion parallel to the direction of elongation of the concave portions of the at least one upper ground members.

In another example, a cable assembly may comprise: a plurality of cables, each of the plurality of cables may comprise at least one wire and a shield; a cable connector may terminate the plurality of cables. The cable connector may comprise: a substrate having a first side comprising: a plurality of signal pads; and at least one ground pad; a cable termination assembly mounted to the first side of the substrate. The cable termination assembly may comprise: a plurality of signal terminals, each of the plurality of signal terminals comprising a mounting end mounted to a signal pad of the plurality of signal pads and a wire connecting end coupled to a wire of a cable of the plurality of cables; and a plurality of ground terminals, each of the plurality of ground terminals comprising a mounting end mounted to a ground pad of the at least one ground pad. A lower ground member may comprise a first end and a second end opposite the first end with a plurality of mounting portions at the second end. The lower ground member may be coupled at the first end to the shields of the plurality of cables and the plurality of mounting portions may be mounted to the at least one ground pad.

Such a cable assembly may optionally comprise one or more of the following features:

The lower ground member may be coupled to the plurality of ground terminals.

The lower ground member may comprise a plurality of wings extending from the mounting portions; and the lower ground member may be coupled to the plurality of ground terminals through the plurality of wings.

The plurality of wings may be welded to respective ground terminals of the plurality of ground terminals.

The mounting ends of the plurality of signal terminals may be mounted to the plurality of signal pads via solder; the mounting ends of the plurality of ground terminals may be mounted to the at least one ground pad via solder; and the mounting portions of the lower ground member may be mounted to the at least one ground pad via solder.

The at least one wire of each of the plurality of cables may be coupled to the wire connecting end of a respective signal terminal of the plurality of signal terminals via solder.

At least one upper ground member, each of the at least one upper ground member may comprise a concave portion. For each upper ground member of the at least one upper ground member: a segment of a respective cable of the plurality of cables may be disposed within the concave portion of the upper ground member with the shield of the respective cable coupled to the upper ground member; and the upper ground member may be mechanically coupled to the cable termination assembly so as to press against the shield of the respective cable and provide electrical coupling between the shield of the respective cable and the upper ground member and the lower ground member.

The upper ground member may further comprise flanges extending from the concave portion; and the upper ground member may be mechanically coupled to the cable termination assembly, at least in part, via welds joining the flanges and ground terminals of the plurality of ground terminals.

The cable termination assembly may further comprise a ground strip joining the plurality of ground terminals; and the ground strip may contact the shields of the plurality of cables.

The first end of the lower ground member may be coupled to the shields of the plurality of cables through the ground strip.

The lower ground member may be welded to the ground strip and/or the plurality of ground terminals.

The upper ground member may further comprise flanges extending from the concave portion; and the upper ground member may be mechanically coupled to the cable termination assembly, as least in part, via solder joining the flanges to the ground strip.

Each upper ground member of the at least one upper ground member may comprise arms connected to respective ground terminals of the plurality of ground terminals.

The lower ground member and the at least one upper ground member may provide a plurality of ground paths providing an insertion loss and a return loss through the connector sufficient to support high frequency signals at a data rate of at least 224 Gbps (PAM4).

The upper ground member may comprise a plurality of upper ground members.

Each upper ground member of the plurality of upper ground members may be electrically coupled to a shield of a respective cable of the plurality of cables.

The cable connector may further comprise an outer housing; the outer housing may comprise a cavity; and the substrate and cable termination assembly may be in the cavity with ends of the plurality of cables coupled to the cable termination assembly within the cavity.

The cable connector may further comprise a cable positioning member within the cavity.

The cable termination assembly may comprise an insulative housing; the plurality of signal terminals and the plurality of ground terminals may be held by the housing with the mounting ends of the plurality of signal terminals and the plurality of ground terminals in a first row; and ends of the plurality of cables may comprise an end segment positioned in a second row, parallel to the first row.

The cable connector may further comprise a cable positioning member holding the plurality of cables in the second row.

Wire connecting ends of the plurality of signal terminals may extend in a plane.

The lower ground member may comprise a planar portion parallel to the plane of the wire connecting ends.

The lower ground member may comprise a planar portion parallel to segments of the plurality of cables held in the second row.

The planar portion may be parallel to the first side of the substrate.

The planar portion may be at an angle of greater than 5 degrees with respect to the first side of the substrate.

The cable termination assembly may be a first cable termination assembly; the plurality of cables may be a first plurality of cables; the cable assembly may further comprise a second plurality of cables; and the cable connector may further comprise a second cable termination assembly mounted to the first side of the substrate. The second plurality of cables may pass over the first cable termination assembly and may be terminated to the second cable termination assembly.

Ends of the first plurality of cables terminated to the first cable termination assembly may be disposed in a first plane parallel to the first side of the substrate; ends of the second plurality of cables terminated to the second cable termination assembly may be disposed in a second plane at an acute angle with respect to the first side of the substrate.

The cable connector may further comprise a second lower ground member comprising a first end and a second end opposite the first end with a plurality of mounting portions at the second end. The second lower ground member may be coupled at the first end to shields of the second plurality of cables at the first end and the plurality of mounting portions may be mounted to the at least one ground pad.

Each of the first and second lower ground members may comprise a planar region at the first end and a mounting region at the second end; for the first lower ground member, the planar region may be parallel to the mounting region; and for the second lower ground member, the planar region may be at an angle between 5 and 30 degrees with respect to the mounting region.

The plurality of signal pads may be a first plurality of signal pads; the substrate may further comprise a second plurality of signal pads; the second cable termination assembly may comprise: a second plurality of signal terminals, each of the second plurality of signal terminals comprising a mounting end mounted to a signal pad of the plurality of signal pads and a wire connecting end coupled to a wire of a cable of the plurality of cables; a second plurality of ground terminals, each of the plurality of ground terminals comprising a mounting end mounted to a ground pad of the at least one ground pad. The connector may further comprise a second plurality of upper ground members, each upper ground member of the second plurality of upper ground members comprising a concave portion; and for each upper ground member of the second plurality of upper ground members: a segment of a respective cable of the second plurality of cables may be disposed within the concave portion of the upper ground member with the shield of the respective cable coupled to the upper ground member; and the upper ground member may be mechanically coupled to the second cable termination assembly so as to press against the shield of the respective cable and provide electrical coupling between the shield of the respective cable and the upper ground member and the second lower ground member.

The substrate may be a paddle card.

The paddle card may comprise a plurality of ground pads.

The cable assembly may further comprise a third plurality of cable and a fourth plurality of cables; the substrate may have a second side opposite the first side; and the cable connector may further comprise: a third cable termination assembly, configured like the first cable termination assembly, terminating the third plurality of cables mounted to the second side; a fourth cable termination assembly, configured like the second cable termination assembly, terminating the fourth plurality of cables mounted to the second side.

In another example, a method of manufacturing a cable assembly may comprise: attaching a first ground member to a first cable termination assembly. The first cable termination assembly may comprise a lead frame comprising an insulative housing holding a plurality of signal terminals and a plurality of ground terminals in a row with ground terminals of the plurality of ground terminals bounding pairs of the plurality of signal terminals. The method may also comprise mounting the first cable termination assembly and the first ground member to a first side of a substrate. The first side of the substrate may comprise a plurality of signal pads and at least one ground pad. The mounting may comprise: soldering mounting ends of the plurality of signal terminals of the first cable termination assembly to respective signal pads of the plurality of signal pads on the first side of the substrate; and soldering mounting ends of the plurality of ground terminals of the first cable termination assembly to the at least one ground pad of the substrate.

Fusing a wire of each of a first plurality of cables to respective wire connecting ends of the plurality of signal terminals of the first cable termination assembly; and coupling shields of each of the plurality of cables to the at least one ground terminal of the first cable termination assembly.

Such a method of manufacture may optionally comprise one or more of the following features and/or include one or more of the following acts:

The fusing the wire of each of the first plurality of cables to respective wire connecting ends of the plurality of signal terminals of the first cable termination assembly may comprise: soldering the wire of the first cable to the wire connecting end of the at least one signal terminal of the first cable termination assembly.

The method may also include attaching a second ground member to a second cable termination assembly. The second cable termination assembly may comprise a lead frame comprising an insulative housing holding a plurality of signal terminals and a plurality of ground terminals in a row with ground terminals of the plurality of ground terminals bounding pairs of the plurality of signal terminals; mounting the second cable termination assembly and the second ground member to the first side of a substrate, the mounting may comprise: soldering mounting ends of the plurality of signal terminals of the second cable termination assembly to respective signal pads of the plurality of signal pads on the first side of the substrate; and soldering mounting ends of the plurality of ground terminals of the second cable termination assembly to the at least one ground pad of the substrate; fusing a wire of each of a plurality of second cables to respective wire connecting ends of the plurality of signal terminals of the second cable termination assembly; and coupling shields of each of the plurality of second cables to the at least one ground terminal of the second cable termination assembly.

The fusing the wire of each of a plurality of second cables to the respective wire connecting ends of the plurality of signal terminals of the second cable termination assembly may comprise: soldering the wire of each of the plurality of second cables to respective wire connecting ends of the plurality of signal terminals of the second cable termination assembly.

The method may also comprise positioning ends of the first plurality of cables fused to the wire connecting end of respective signal terminals of the first cable termination assembly to be substantially parallel to the substrate.

The method may also comprise positioning ends of the second plurality of cables fused to the wire connecting ends of the plurality of signal terminals of the second cable termination assembly at an acute angle with respect to the substrate.

The method may also comprise molding a cable positioning member over the first plurality of cables to hold the first plurality of cables in a position adjacent to the first cable termination assembly.

The method may also comprise positioning concave portions of at least one ground member over the ends of the first plurality of cables fused to the wire connecting ends of the plurality of signal terminals of the first cable termination assembly so as to urge the first plurality of cables toward the first cable termination assembly.

The method may also comprise positioning the first ground member of the first cable termination assembly substantially parallel to the substrate.

The method may also comprise positioning the second ground member of the second cable termination assembly to form an acute angle with the substrate.

The attaching the first ground member to the first cable termination assembly may comprise: welding the first ground plate to the first cable termination assembly.

The soldering mounting ends of the plurality of signal terminals of the first cable termination assembly to respective signal pads of the plurality of signal pads on the first side of the substrate may comprise: surface mount soldering the mounting ends of the plurality of signal terminals of the first cable termination assembly to respective signal pads of the plurality of signal pads on the first side of the substrate.

The substrate has a second side opposite the first side, the second side comprising a plurality of signal pads and at least one ground pad.

The method may also comprise: attaching a third ground plate to a third cable termination assembly, the third cable termination assembly comprising a lead frame comprising an insulative housing holding a plurality of signal terminals and a plurality of ground terminals in a row with ground terminals of the plurality of ground terminals bounding pairs of the plurality of signal terminals; mounting the third cable termination assembly and the third ground plate to the second side of a substrate, the second side of the substrate comprising a plurality of signal pads and at least one ground pad, the mounting comprising: soldering mounting ends of the plurality of signal terminals of the third cable termination assembly to respective signal pads of the plurality of signal pads on the second side of the substrate; and soldering mounting ends of the plurality of ground terminals of the third cable termination assembly to the at least one ground pad of the second side of the substrate.

The method may also comprise: fusing a wire of each of a third plurality of cables to respective wire connecting ends of the plurality of signal terminals of the third cable termination assembly; coupling shields of each of the third plurality of cables to the at least one ground terminal of the third cable termination assembly.

The soldering the mounting ends of the plurality of signal terminals of the third cable termination assembly to respective signal pads of the plurality of signal pads on the second side of the substrate may comprise: reflow soldering the mounting ends of the plurality of signal terminals of the third cable termination assembly to respective signal pads of the plurality of signal pads on the second side of the substrate.

The soldering the mounting ends of the plurality of ground terminals of the third cable termination assembly to the at least one ground pad of the second side of the substrate may comprise: reflow soldering the mounting ends of the plurality of ground terminals of the third cable termination assembly to the at least one ground pad of the second side of the substrate.

The method may also comprise: positioning the first ground member below the first plurality of cables so that a portion of the first ground member is substantially parallel to a plane in which the wire of each of the first plurality of cables is fused to the respective wire connecting ends of the plurality of signal terminals of the first cable termination assembly and so that the first ground member is aligned with a portion of at least one of the plurality of first cables in which the shield is exposed.

The method may also comprise: disposing a segment of a respective cable of the plurality of cables within concave portions of a plurality of upper ground members with a shield of the respective cable coupled to the upper ground member.

The method may also comprise: electrically coupling the shield of the respective cable of the plurality of cables to the plurality of upper ground members.

The method may also comprise: positioning the first ground member and the plurality of upper ground members to provide a plurality of ground paths controlling an insertion loss and a return loss sufficiently to support conduction of high frequency signals.

The disclosed technology is not limited in its application to the details of construction and the arrangement of components set forth in the preceding description or as illustrated in the drawings. The disclosed technology is capable of other embodiments and of being practiced or of being carried out in various was. Also, the phraseology and terminology used herein is for the purpose of description and should not be regarded as limiting. The use of “including,” “comprising,” “having,” “containing,” or “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art.

For example, cable termination assemblies are depicted as having one row of terminals. In other examples, a cable termination assembly may have two or more of terminals.

As another example, cable termination assemblies were pictured with one lower ground member and multiple upper ground members. In other examples, a cable termination assembly may have multiple lower ground members and/or a single unitary upper ground member.

Further, two cable termination assemblies were pictured mounted to each side of a paddle card. Cable termination assemblies may be mounted to only one side or different numbers of cable termination assemblies may be mounted on each side. Further, the forward and rearward cable termination assemblies are shown to have different shapes. If more than two cable termination assemblies are mounted to the same side of a paddle card, a connection assembly may have more than two types of cable termination assemblies. However, in some examples, multiple cable termination assemblies 212B may be used on one side.

Further, a paddle card was described as an example of a substrate in a cable connector. Other substrates may be used instead or in addition to a paddle card. A substrate, for example, might be formed of other materials or might be formed in other ways, such as by insert molding conductive elements, in a tongue of plastic or other insulative material, to form one or more members that may serve as a substrate.

A paddle card is shown with two footprints (610A and 610B) on each side of the paddle card. In other examples, more than two footprints may be on each side or less than two footprints may be on each side. For example, one side may have no footprints. In some examples, the footprints may be substantially identical, with pads of the same size and shape disposed in a row for mounting terminals of a cable termination assembly. Accordingly, though FIG. 6 shows signal pads of different shapes in footprints 610A and 610B, such is not a requirement of the invention. However, in some examples, pads of different shape may provide different amounts of mechanical retention and may be used, such as to accommodate for different forces applied to cables attached to different ones of the cable termination assemblies.

Such alterations, modifications, and improvements are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, circuits and modules depicted and described may be reordered in any order, and signals may be provided to enable reordering accordingly.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A subassembly for a cable connector, comprising:
a cable termination assembly comprising:
an insulative housing;
a plurality of signal terminals held within the insulative housing, each of the plurality of signal terminals comprising a mounting end configured for mounting to a surface of a substrate and a wire connecting end; and
a plurality of ground terminals held within the insulative housing, each of the plurality of ground terminals comprising a mounting end configured for mounting to the surface of the substrate; and
a ground member mounted to the cable termination assembly and comprising a plurality of mounting portions configured for mounting to the surface of the substrate.

2. The subassembly of claim 1, wherein:
the mounting ends of the plurality of signal terminals and the plurality of ground terminals are co-planar with the mounting portions of the ground member; and
the plurality of signal terminals and the plurality of ground terminals are held by the housing in a row with signal terminals of the plurality of signal terminals disposed between ground terminals of the plurality of ground terminals.

3. The subassembly of claim 1, wherein:
the ground member further comprises wings extending from the mounting portions; and
each of the wings is attached to a respective ground terminal of the plurality of ground terminals.

4. The subassembly of claim 3, wherein:
each of the wings is attached to the respective ground terminal of the plurality of ground terminals at the mounting end of the respective ground terminal.

5. The subassembly of claim 1, wherein:
the cable termination assembly further comprises a ground strip connecting the plurality of ground terminals at an end opposite the mounting ends of the ground terminals.

6. The subassembly of claim 5, wherein:
the ground member has a planar portion affixed to the ground strip;
the ground member has a side portion configured for mounting to the surface of the substrate; and
the side portion is at an angle within the range of +/−5 degrees with respect to the planar portion.

7. The subassembly of claim 5, wherein:
the plurality of mounting portions are disposed in a plane; and
the plane is at an angle within the range of +/−5 degrees with respect to the ground strip or the plane is at an angle greater than 5 degrees with respect to the ground strip.

8. The subassembly of claim 7, wherein:
the ground member has a side portion configured for mounting to the surface of the substrate;
the plane is at an angle within the range of +/−5 degrees with respect to the ground strip; and
the side portion is at an angle within the range of +/−5 degrees with respect to the planar portion.

9. A cable connection assembly comprising the subassembly of claim 1, wherein:
the cable termination assembly is a first cable termination assembly comprising:
the plurality of signal terminals is a first plurality of signal terminals; and
the plurality of ground terminals is a first plurality of ground terminals;
the ground member is a first ground member;
the substrate has a first side, the first side comprising:
a first plurality of signal pads; and
at least one ground pad;
the mounting ends of the first plurality of signal terminals are coupled to respective pads of the first plurality of signal pads, and
the mounting ends of the plurality of ground terminals and the mounting portions of the ground member are each coupled to a ground pad of the at least one ground pad.

10. The cable connection assembly of claim 9, further comprising:
a second cable termination assembly, comprising:
a second plurality of signal terminals, each of the second plurality of signal terminals comprising a mounting end and a wire connecting end; and
a second plurality of ground terminals, each of the second plurality of ground terminals comprising a mounting end;
a second ground member coupled to the second cable termination assembly and comprising a plurality of mounting portions,
wherein:
the substrate further comprises a second plurality of signal pads;
the mounting ends of the second plurality of signal terminals are coupled to respective pads of the second plurality of signal pads, and
the mounting ends of the second plurality of ground terminals and the mounting portions of the second ground member are each coupled to a ground pad of the at least one ground pad.

11. A cable connector comprising the subassembly of claim 1 and further comprising:
an outer housing comprising a cavity;
a cable connection assembly disposed within the cavity, the cable connection assembly comprising:
the substrate having a first side, the first side comprising:
a plurality of signal pads; and
at least one ground pad;
wherein:
the mounting ends of the plurality of signal terminals are coupled to respective pads of the plurality of signal pads;
the mounting ends of the plurality of ground terminals are coupled to the at least one ground pad; and
for each of the at least one ground members, the ground member is attached to ground terminals of the plurality of ground terminals of a respective cable termination assembly and the at least one ground pad.

12. The cable connector of claim 11, further comprising:
a second cable termination assembly, wherein
the cable termination assembly is configured to receive a first plurality of cables routed to the cable termination assembly at a first angle with respect to the substrate;
the second cable termination assembly is configured to receive a second plurality of cables routed to the second cable termination assembly at a second angle with respect to the substrate; and
the second angle is larger than the first angle.

13. A cable assembly, comprising:
a plurality of cables, each of the plurality of cables comprising at least one wire and a shield;
a cable connector terminating the plurality of cables, the cable connector comprising:
a substrate having a first side comprising:
a plurality of signal pads; and
at least one ground pad;
a cable termination assembly mounted to the first side of the substrate, the cable termination assembly comprising:
a plurality of signal terminals, each of the plurality of signal terminals comprising a mounting end mounted to a signal pad of the plurality of signal pads and a wire connecting end coupled to a wire of a cable of the plurality of cables; and
a plurality of ground terminals, each of the plurality of ground terminals comprising a mounting end mounted to a ground pad of the at least one ground pad; and
a lower ground member comprising a first end and a second end opposite the first end with a plurality of mounting portions at the second end, wherein the lower ground member is coupled at the first end to the shields of the plurality of cables and the plurality of mounting portions are mounted to the at least one ground pad.

14. The cable assembly of claim 13, wherein the cable connector further comprises:
at least one upper ground member, each of the at least one upper ground member comprising a concave portion,
wherein, for each upper ground member of the at least one upper ground member:
a segment of a respective cable of the plurality of cables is disposed within the concave portion of the upper ground member with the shield of the respective cable coupled to the upper ground member; and
the upper ground member is mechanically coupled to the cable termination assembly so as to press against the shield of the respective cable and provide electrical coupling between the shield of the respective cable and the upper ground member and the lower ground member.

15. The cable assembly of claim 13, wherein:
the cable termination assembly is a first cable termination assembly;
the plurality of cables are a first plurality of cables;
the cable assembly further comprises a second plurality of cables;
the cable connector further comprises
a second cable termination assembly mounted to the first side of the substrate,
wherein the second plurality of cables passes over the first cable termination assembly and are terminated to the second cable termination assembly
ends of the first plurality of cables terminated to the first cable termination assembly are disposed in a first plane parallel to the first side of the substrate;
ends of the second plurality of cables terminated to the second cable termination assembly are disposed in a second plane at an acute angle with respect to the first side of the substrate;
the cable connector further comprises a second lower ground member comprising a first end and a second end opposite the first end with a plurality of mounting portions at the second end, wherein the second lower ground member is coupled at the first end to shields of the second plurality of cables at the first end and the plurality of mounting portions are mounted to the at least one ground pad;
each of the first and second lower ground members comprises a planar region at the first end and a mounting region at the second end;
for the first lower ground member, the planar region is parallel to the mounting region; and
for the second lower ground member, the planar region is at an angle between 5 and 30 degrees with respect to the mounting region.

16. A method of manufacturing a cable assembly, comprising:
attaching a first ground member to a first cable termination assembly, wherein the first cable termination assembly comprises a lead frame comprising an insulative housing holding a plurality of signal terminals and a plurality of ground terminals in a row with ground terminals of the plurality of ground terminals bounding pairs of the plurality of signal terminals; and
mounting the first cable termination assembly and the first ground member to a first side of a substrate, wherein the first side of the substrate comprises a plurality of signal pads and at least one ground pad, the mounting comprising:
soldering mounting ends of the plurality of signal terminals of the first cable termination assembly to respective signal pads of the plurality of signal pads on the first side of the substrate; and
soldering mounting ends of the plurality of ground terminals of the first cable termination assembly to the at least one ground pad of the substrate.

17. The method of manufacturing a cable assembly of claim 16, further comprising:
fusing a wire of each of a first plurality of cables to respective wire connecting ends of the plurality of signal terminals of the first cable termination assembly;
coupling shields of each of the plurality of cables to the at least one ground terminal of the first cable termination assembly; and
positioning the first ground member below the first plurality of cables so that a portion of the first ground member is substantially parallel to a plane in which the wire of each of the first plurality of cables is fused to the respective wire connecting ends of the plurality of signal terminals of the first cable termination assembly and so that the first ground member is aligned with a portion of at least one of the plurality of first cables in which the shield is exposed.

18. The method of manufacturing the cable assembly of claim 17, further comprising:
disposing a segment of a respective cable of the plurality of cables within concave portions of a plurality of upper ground members with a shield of the respective cable coupled to the upper ground member; and
electrically coupling the shield of the respective cable of the plurality of cables to the plurality of upper ground members.

19. The method of manufacturing the cable assembly of claim 16, further comprising:
attaching a second ground member to a second cable termination assembly wherein the second cable termination assembly comprises a lead frame comprising an insulative housing holding a plurality of signal terminals and a plurality of ground terminals in a row with ground terminals of the plurality of ground terminals bounding pairs of the plurality of signal terminals;
mounting the second cable termination assembly and the second ground member to the first side of a substrate, the mounting comprising:
soldering mounting ends of the plurality of signal terminals of the second cable termination assembly to respective signal pads of the plurality of signal pads on the first side of the substrate; and
soldering mounting ends of the plurality of ground terminals of the second cable termination assembly to the at least one ground pad of the substrate;
fusing a wire of each of a plurality of second cables to respective wire connecting ends of the plurality of signal terminals of the second cable termination assembly; and
coupling shields of each of the plurality of second cables to the at least one ground terminal of the second cable termination assembly.

20. The method of manufacturing the cable assembly of claim 19, further comprising:
positioning the first ground member of the first cable termination assembly substantially parallel to the substrate; and
positioning the second ground member of the second cable termination assembly to form an acute angle with the substrate.
